(19) United States
(12) Patent Application Publication
(10) Pub. No.: US 2022/0350447 A1
(43) Pub. Date: Nov. 3, 2022

(54) EDITOR FOR THE CREATION AND MODIFICATION OF DATA MODEL METADATA

(71) Applicant: Microsoft Technology Licensing, LLC, Redmond, WA (US)

(72) Inventors: Manohar SREENIVASACHAR, Sunnyvale, CA (US); Michael Allan JOHNSTON, Santa Clara, CA (US); Degant PURI, Bellevue, WA (US)

(21) Appl. No.: 17/360,101

(22) Filed: Jun. 28, 2021

Related U.S. Application Data
(60) Provisional application No. 63/180,988, filed on Apr. 28, 2021.

(51) Int. Cl. G06F 3/0482; G06F 9/451; G06F 16/11; G06F 3/0484; G06F 40/166; G06F 40/226

(52) U.S. Cl. CPC G06F 3/0482; G06F 9/451; G06F 16/116; G06F 3/0484; G06F 40/166; G06F 40/226

(57) ABSTRACT

A data model metadata editor is described that may be integrated within a customer data platform. The editor enables a user to create and/or edit data model metadata by implementing a graphical user interface (GUI) that prompts the user to provide input and make selections in a manner that accords with rules concerning what information such metadata must include and how the contents of such metadata should be organized and formatted. Furthermore, the editor may perform syntax checking, validate such input and selections against the aforementioned rules, and flag any detected errors and/or potential problems to the user. Still further, the editor may apply the data model metadata (e.g., data schemas) to actual customer data and present the results to the user within the editor GUI so that the user can visually confirm that changes made to the data model metadata accord with the customer data.

### CROSS-REFERENCE TO RELATED APPLICATIONS

This application claims priority to U.S. Provisional Patent Application Ser. No. 63/180,988, filed Apr. 28, 2021, the entirety of which is incorporated by reference herein.

### BACKGROUND

A data model is an abstract model that organizes elements of data and standardizes how they relate to one another and to the properties of real-world entities. Common Data Model (CDM) is one example of a data model. CDM includes a set of standardized, extensible data schemas. This collection of predefined schemas includes entities, attributes, semantic metadata, and relationships. The schemas represent commonly used concepts and activities, such as “Account” and “Campaign,” to simplify the creation, aggregation, and analysis of data. Data stored in accordance with the Common Data Model provides semantic consistency across applications and deployments.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A data model metadata editor is described herein that enables a user to create or modify data model metadata associated with data stored in one or more data files. The data model metadata editor may be integrated within a customer data platform. In an embodiment, the data model metadata editor makes it easy for a user to create and/or modify the data model metadata by implementing a graphical user interface (GUI) that prompts the user to provide input and make selections in a manner that accords with rules concerning what information such metadata must include and how the contents of such metadata should be organized and formatted. Furthermore, the data model metadata editor may perform syntax checking, validate such input and selections against the aforementioned rules, and flag any detected errors and/or potential problems to the user. Still further, the data model metadata editor may apply the metadata included in the data model metadata files (e.g., data schemas) to actual customer data and present the results to the user within the editor GUI so that the user can visually confirm that changes made to the data model metadata accord with the customer data. In this way, the metadata model editor both makes it easier for the user to create/modify the data model metadata and automatically ensures that the data model metadata is correct prior to ingestion of the data into the customer data platform.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the application and, together with the description, further explain the principles of the embodiments and to enable a person skilled in the relevant art(s) to make and use the embodiments.

FIG. 1A illustrates contents of a first example Common Data Model folder.

FIG. 1B illustrates contents of a second example Common Data Model folder.

FIG. 2 is a block diagram of a system that includes a customer data platform having an integrated CDM editor that enables a user to create and modify one or more CDM metadata files included in a CDM folder.

FIG. 3 is a screenshot that depicts an example GUI of the customer data platform of FIG. 2 via which a user may access the CDM editor.

FIG. 4-23 show different screenshots of the GUI of the CDM editor of FIG. 2.

FIG. 24 depicts a flowchart of a computer-implemented method for creating or modifying data model metadata associated with data stored in one or more data files.

FIG. 25 shows an additional step that may be performed as part of the computer-implemented method depicted in FIG. 24.

FIG. 26 shows one manner in which the step of FIG. 25 may be carried out.

FIG. 27 shows another manner in which the step of FIG. 26 may be carried out.

FIG. 28 depicts a flowchart of additional steps that may be performed as part of the computer-implemented method depicted in FIG. 24.

FIG. 29 depicts an example processor-based computer system that may be used to implement various embodiments described herein.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

The example embodiments described herein are provided for illustrative purposes and are not limiting. The examples described herein may be adapted to any type of method or system for securing access to computing resources of an accessory device. Further structural and operational embodiments, including modifications/alterations, will become apparent to persons skilled in the relevant art(s) from the teachings herein.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A data model is an abstract model that organizes elements of data and standardizes how they relate to one another and to the properties of real-world entities.

Common Data Model (CDM) is one example of a data model. CDM is an open source data model that includes a set of standardized, extensible data schemas. This collection of predefined schemas includes entities, attributes, semantic metadata, and relationships. The schemas represent commonly used concepts and activities, such as “Account” and “Campaign,” to simplify the creation, aggregation, and analysis of data. Data stored in accordance with the Common Data Model provides semantic consistency across applications and deployments.

Common Data Model utilizes a metadata system that enables structural consistency and semantic meaning to be uniformly applied to data, such as data stored in a data lake, using hierarchical namespaces and folders that contain schematized data in standard Common Data Model format. The standardized metadata and self-describing data facilitates metadata discovery and interoperability between data producers and data consumers.

Certain terms relating to CDM will now be defined.

Common Data Model folder: A folder in a data lake instance that conforms to specific, well-defined, and standardized metadata structures and self-describing data. These folders facilitate metadata discovery and interoperability between data producers and data consumers.

*.manifest.cdm.json: A metadata file in a folder in a data lake instance that follows the Common Data Model metadata format and potentially references other sub-manifests for nested solutions. The presence of this file in a folder implies that the folder is a Common Data Model folder.

*.model.json: A metadata file in a folder in a data lake instance that follows the Common Data Model metadata format. The presence of this file in a folder implies that the folder is a Common Data Model folder.

*.cdm.json: A metadata file in the Common Data Model folder. When such a file has a name <entity_name>.cdm.json, then it contains the metadata about the specific entity, its attributes, semantic meanings of entity and attributes. A *.cdm.json file can also represent a “definitions file” that can be imported into a manifest. Such definition files can contain shared definitions that can be referenced in <entity_name>.cdm.json files. For example, a file “extraTraits.cdm.json” can exist. A “default.manifest.cdm.json” file can have an “import” pointing to this file. Once imported, an entity “entity1.cdm.json” can use a declared trait “is.vacationing”.

Data producer: A service or application that creates data in Common Data Model folders in a data lake instance.

Data consumer: A service or application that consumes data in Common Data Model folders in a data lake instance.

Each Common Data Model folder contains the following elements: (a) either (i) the *.manifest.cdm.json file(s) and one or more *.cdm.json files or (ii) the model.json file; and (b) the data files.

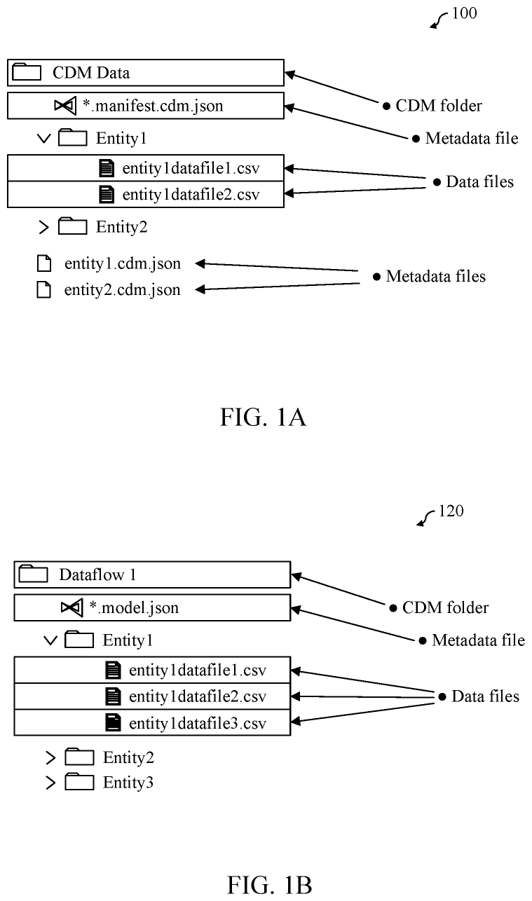

FIG. 1A illustrates the contents 100 of a first example Common Data Model folder. As shown in FIG. 1A, the Common Data Model folder includes a *.manifest.cdm.json metadata file, a plurality of <entity_name>.cdm.json metadata files, and a plurality of data files. In this example, the entity1.cdm.json metadata file corresponds to Entity1 and the entity2.cdm.json metadata file corresponds to Entity2. Furthermore, in this example, only two data files are shown—namely, entity1datafile1.csv and entity1datafile2.csv, each of which is stored within the subfolder “Entity1” and correspond to Entity1. The Entity2 subfolder may store data files corresponding to Entity2.

FIG. 1B illustrates the contents 120 of a second example Common Data Model folder. As shown in FIG. 1B, the Common Data Model folder includes the *.model.json metadata file and a plurality of data files. In this example, only three data files are shown—namely, entity1datafile1.csv, entity1datafile2.csv, and entity1datafile3.csv, each of which is stored within the subfolder “Entity1” and correspond to Entity1. The Entity2 and Entity 3 subfolders may each store data files corresponding to Entity2 and Entity3, respectively.

The *.manifest.cdm.json file contains information about the content of Common Data Model folder, entities comprising the folder, and relationships and links to underlying data files. The *.manifest.cdm.json format allows for multiple manifests stored in the single folder providing an ability to scope data for different data consuming solutions for various personas or business perspectives. Each entity definition is in an individual file making managing, navigation, and discoverability of entity metadata easier and more intuitive. It is noted that there can be a “parent” manifest file and one or more sub-manifest files that are referenced by the “parent” manifest file, wherein each of these files follows the *.manifest.cdm.json naming format.

The *.cdm.json file contains the definition for each Common Data Model entity and location of data files for each entity.

The *.model.json metadata file contains semantic information about entity records and attributes, and links to underlying data files. The existence of this file indicates compliance with the Common Data Model metadata format. The file might include standard entities that provide more built-in, rich semantic metadata that applications can leverage.

The data files in a Common Data Model folder have a well-defined structure and format (subfolders are optional) and are referenced in the *.manifest.cdm.json file(s) or in the model.json file. These files are often formatted in accordance with the .csv format, but other formats may also be supported.

A customer data platform (such as Microsoft® Dynamics 365® Customer Insights) may enable users thereof to provide customer data thereto via a process sometimes referred to as data load and ingestion. For example, the customer data platform may enable administrators to load customer data from disparate data sources. Once all the customer data is loaded, the customer data platform may then perform operations on such customer data. For example, the customer data platform may standardize the data and apply artificial intelligence (AI) to automatically match and merge customer data from various data sources. A comprehensive customer profile may then be created and persisted. Organizations may then enrich customer profiles with brand affinity and interest information from other sources. AI and machine learning (ML) may then be applied to this persistent customer data to derive insights and key performance indicators (KPIs) that power personalized experiences and optimize business processes across all channels of engagement.

As noted above, the data load and ingestion process is a necessary prelude to the customer data platform performing operations on the customer data. In some scenarios, the customer data may already be formatted in the aforementioned CDM format and situated in a data lake that is accessible to the customer data platform. In such scenarios, an administrator may mount the customer data directly into the customer data platform through a reference to a CDM model.json file or a manifest.cdm.json file.

In a conventional implementation, the administrator must manually (e.g., using a text editor or code editor) create either the *.model.json file or the *manifest.cdm.json/*.cdm.json files that adhere to the CDM format and upload these to the data lake. The administrator can then mount these files into the customer data platform in the manner described above. However, if the administrator makes a mistake in preparing the model.json or *manifest.cdm.json/*cdm.json files that is detected only after ingestion, then she will have to download the relevant metadata file(s) from the data lake, make any necessary edits, re-upload the relevant metadata file(s) to the data lake, and then interact with the customer data platform to ingest the files again. This is a tedious process for the user. Also, having to ingest the data files multiple times wastes system resources (e.g., processing power, network bandwidth, etc.).

Furthermore, if errors in the *.model.json or *manifest.cdm.json/*.cdm.json files are not identified and corrected prior to ingestion, this can lead to various technical problems. For example, a data schema defined by the *.model.json or *manifest.cdm.json/*.cdm.json files may be out of synch with the actual customer data stored on the data lake, such that the customer data includes more or less columns than otherwise indicated by the data schema. This can lead to system errors during ingestion. As another example, there could be a data type mismatch (e.g., a string attribute may be marked as a numeric attribute) which could also cause system errors during ingestion. As yet another example, the *.model.json or *manifest.cdm.json/*cdm.json files may specify one or more incorrect data partitions or data partition patterns such that customer data files are missed during ingestion.

Additionally, even if ingestion completes successfully with an incorrect *.model.json or *manisfest.cdm.json/*.cdm.json file, any applications or services that will receive and process such data will utilize these metadata files, and in particular the data schemas defined therein, to interpret the customer data. Thus, these applications and services may encounter technical issues utilizing this data (e.g., exceptions and crashes) and/or produce incorrect outputs.

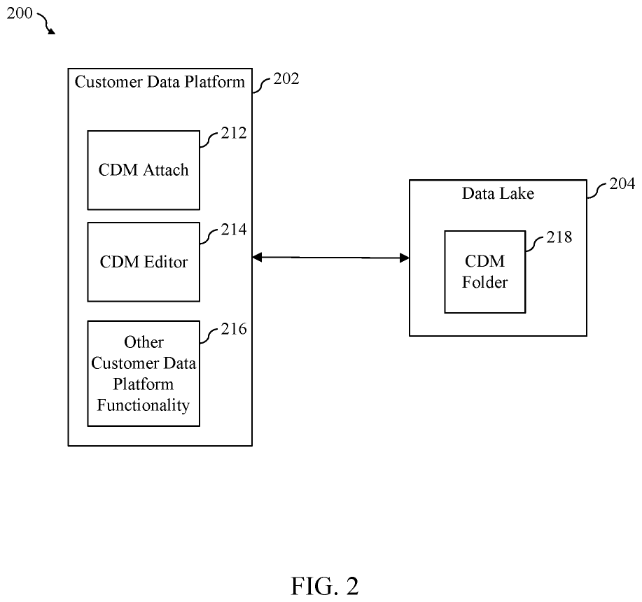

FIG. 2 depicts a system 200 that includes a CDM editor that addresses some or all of the foregoing issues in accordance with an embodiment. As shown in FIG. 2, system 200 includes a customer data platform 202 (e.g., Microsoft® Dynamics 365® Customer Insights) that is connected to a data lake 204 (e.g., a Microsoft® Azure® data lake) that stores a CDM folder 218. CDM folder 218 may be, for example, one of the two different CDM folder types shown in FIGS. 1A and 1B, respectively. As further shown in FIG. 2, customer data platform 202 further includes a CDM Attach Utility 212, a CDM editor 214, and other customer data platform functionality 216.

CDM attach utility 212 enables a user to mount customer data stored in CDM folder 218 stored on data lake 204 directly into customer data platform 202 through a reference to a CDM *.model.json file or a *.manifest.cdm.json file included in CDM folder 218.

CDM editor 214 is integrated within customer data platform 202. That is to say, the graphical user interface (GUI) of CDM editor 214 forms part of (or is otherwise accessible from within) a GUI of customer data platform 202. CDM editor 214 enables a user to create and/or edit the CDM *.model.json or *manifest.cdm.json/*.cdm.json files that are included in CDM folder 218. CDM editor 214 makes it easy for a user to create and/or modify the *.model.json or *manifest.cdm.json/*.cdm.json files by implementing a GUI that prompts the user to provide input and make selections in a manner that accords with rules concerning what information such files must include and how the contents of such files should be organized and formatted. Furthermore, CDM editor 214 may perform syntax checking, validate such input and selections against the aforementioned rules, and flag any detected errors and/or potential problems to the user. Still further, CDM editor 214 may apply the metadata included in the *.model.json or *manifest.cdm.json/*.cdm.json files (e.g., data schemas, partition location paths, partition location patterns) to actual customer data included in CDM folder 218 and present the results to the user within the GUI of CDM editor 214 so that the user can visually confirm that changes made to the data model metadata accord with the customer data. In this way, CDM editor 214 both makes it easier for the user to create/modify these files and automatically ensures that the CDM metadata included in such files is correct prior to data ingestion, thereby avoiding or minimizing the issues discussed above.

As further shown in FIG. 2, customer data platform 202 includes other functionality 216. For example, as discussed above, customer data platform 202 may include functionality for standardizing ingested customer data from various data sources and applying AI to automatically match and merge that data, functionality for creating and persisting a comprehensive customer profile based on that data, functionality for enabling organizations to enrich customer profiles with brand affinity and interest information from other sources, and functionality for applying AI and ML to the persistent customer data to derive insights and KPIs that power personalized experiences and optimize business processes across all channels of engagement.

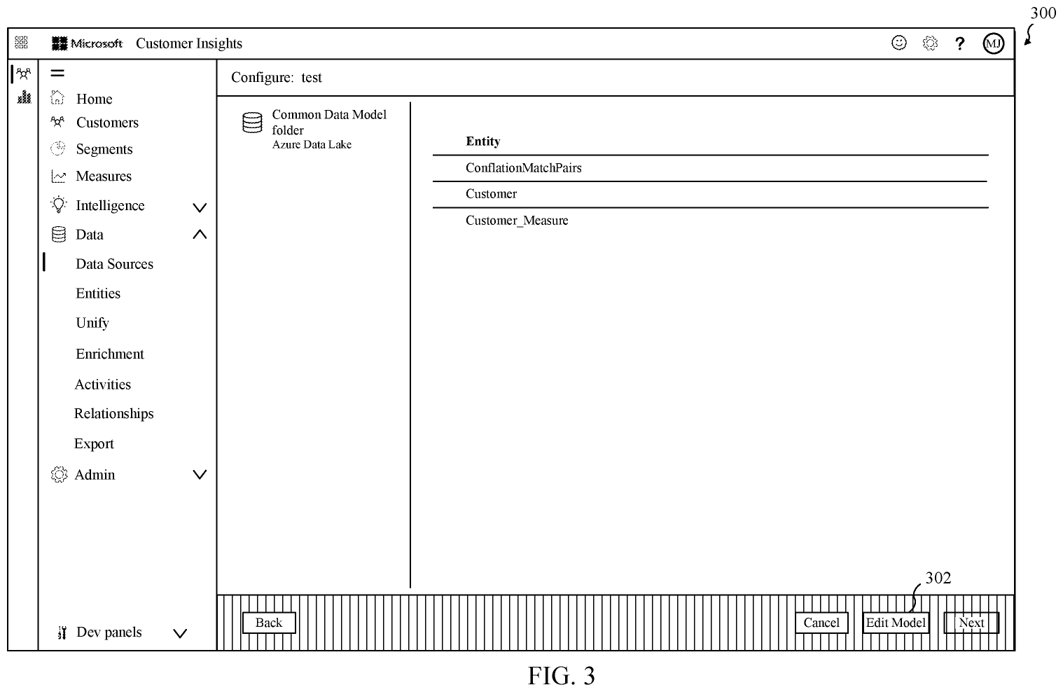

FIG. 3 depicts an example GUI of customer data platform 202 via which a user may access CDM editor 214 in accordance with an embodiment. In particular, FIG. 3 is a screenshot 300 that shows the GUI of customer data platform 202 after the user has selected a CDM folder (e.g., CDM folder 218) stored on data lake 204. After the CDM folder has been selected, customer data platform 202 presents an “edit model” button 302 within the GUI. If the user clicks on or otherwise interacts with “edit model” button 302, then customer data platform 202 will launch CDM editor 214.

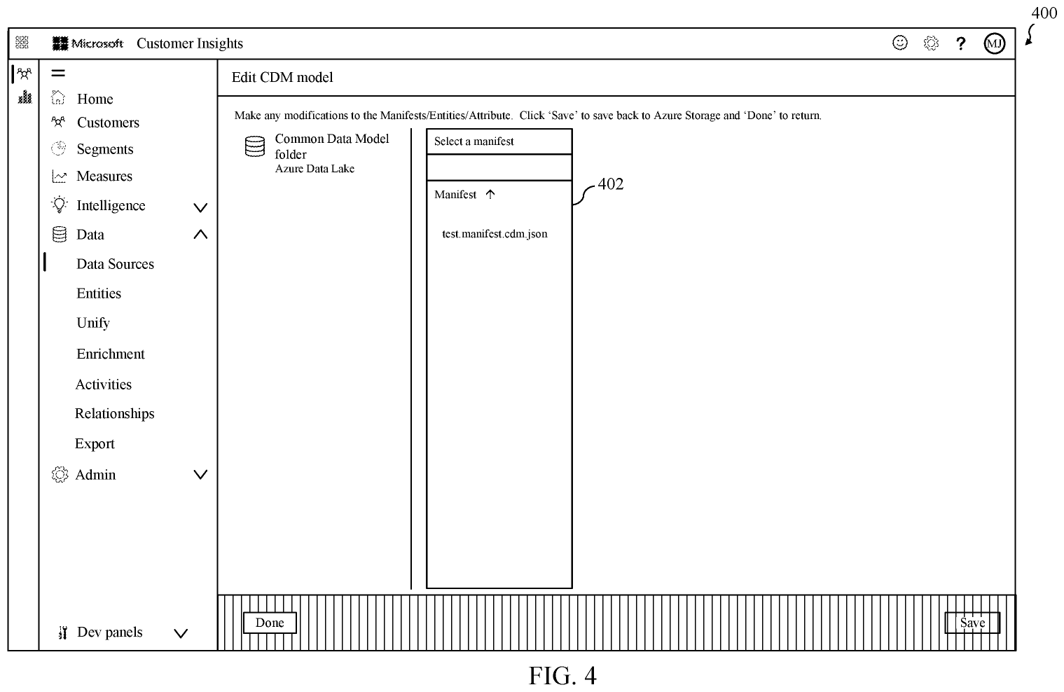

FIG. 4 is a screenshot 400 that shows an initial state of the GUI of CDM editor 214 after it has been launched responsive to the activation of “edit model” button 302 discussed above in reference to FIG. 3. As shown in FIG. 4, CDM editor 214 has automatically detected the presence of the metadata file test.manifest.cdm.json in the selected CDM folder and accordingly has presented the name of the metadata file within a menu of selectable manifests 402. If there were additional manifests within the CDM folder, the names of those manifests would also be displayed in menu 402. The user can select a manifest from menu 402 by clicking on or otherwise interacting with the name of the corresponding *.manifest.cdm.json file. In this particular example, there is only one such file that can be selected.

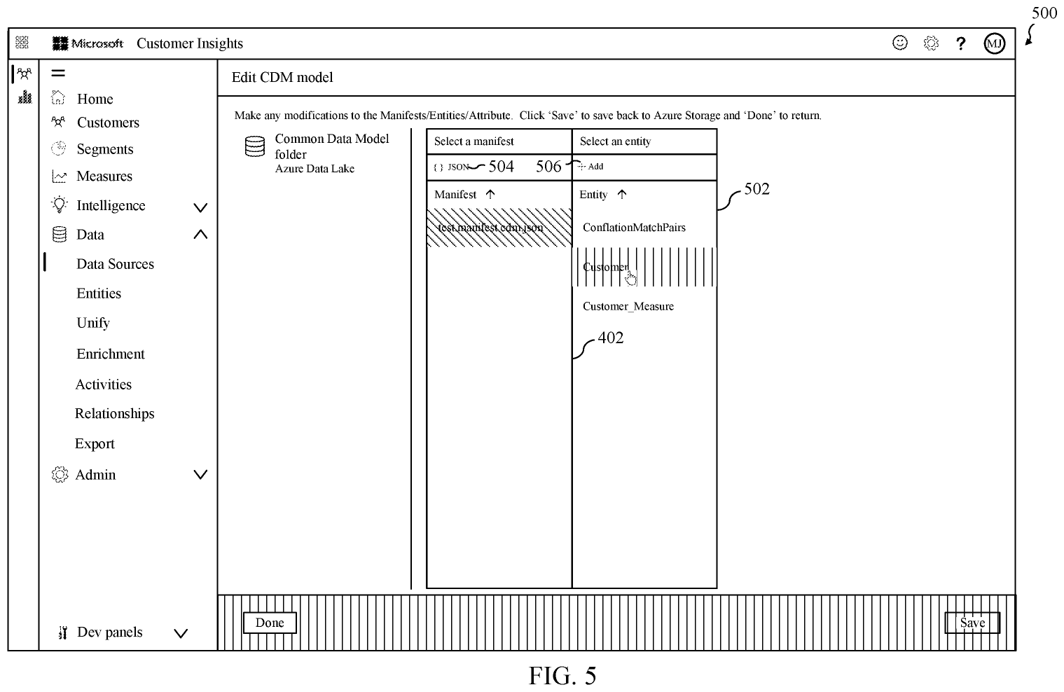

FIG. 5 is a screenshot 500 that shows the state of the GUI of CDM editor 214 after the user has selected the test.manifest.cdm.json file. In response to the selection of that file, CDM editor 214 highlights the test.manifest.cdm.json file in the manner shown in FIG. 5. In further response to the selection of that file, CDM editor 214 also parses the metadata included therein (and potentially in other related metadata files) to determine the entities referenced by such metadata. CDM editor 214 then presents the names of such entities to the user as selectable items within a menu of entities 502. As can be seen in FIG. 5, those entity names include ConflationMatchPairs, Customer, and Customer_Measure. In FIG. 5, the user is hovering a pointer over Customer entity. Responsive to this hover interaction, CDM editor 214 highlights the Customer entity in the manner shown in FIG. 5.

As also shown in FIG. 5, a GUI control 504 labeled “{ } JSON” is located at the top of manifest menu 402. In an embodiment, CDM editor 214 presents GUI control 504 in response to the user selecting a manifest from manifest menu 402. In an alternate embodiment, CDM editor 214 transitions GUI control 504 from being grayed out to solid in response to the user selecting a manifest from manifest menu 402. This transition signals to the user that GUI control 504 has transitioned from a non-interactive state to an interactive state—i.e., a state in which the “{ } JSON” GUI control 504 can be interacted with (e.g., clicked on).

If the user interacts with “{ } JSON” GUI control 504 at the top of manifest menu 402, then CDM editor 214 will cause the raw JSON of the test.manifest.cdm.json file to be presented in a window within the GUI of CDM editor 214. The user can directly edit the JSON displayed within this window to modify the file, as opposed to using the guided menu-driven experience discussed herein. CDM editor 214 may update the JSON shown in the window to reflect changes made via the guided menu-driven experience and, likewise, CDM editor 214 may update the information shown as part of the guided menu-driven experience to reflect direct changes made to the JSON shown in the window.

As further shown in FIG. 5, a GUI control 506 labeled “+Add” is located at the top of entity menu 502. The user may click on or otherwise interact with the “+Add” GUI control 506 to begin the process of adding an entity to the manifest.

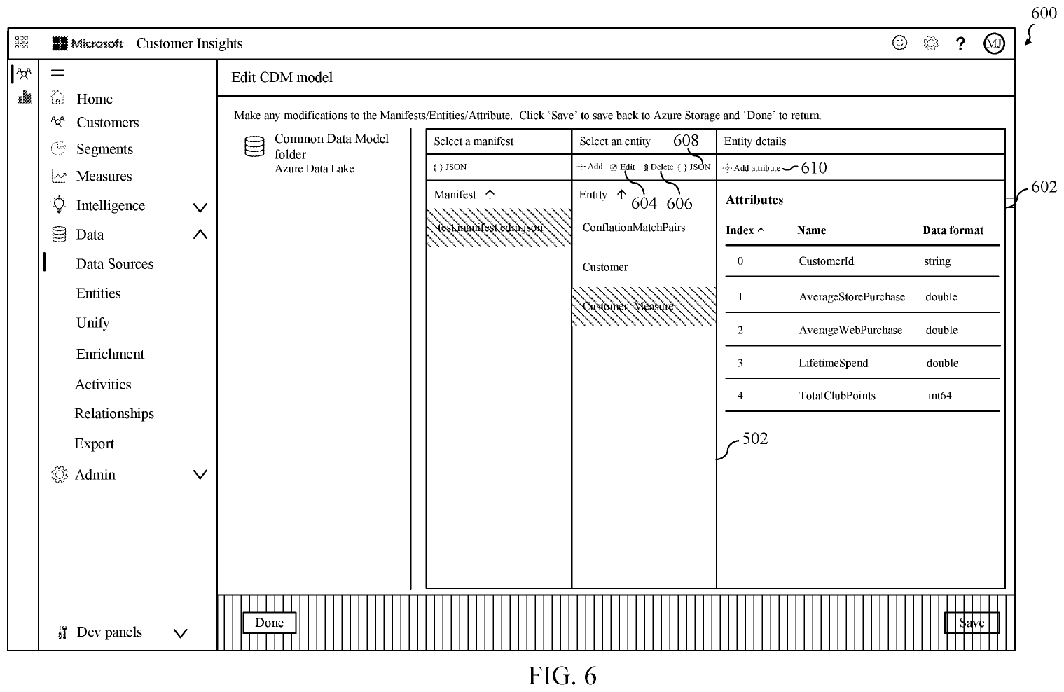

FIG. 6 is a screenshot 600 that shows the state of the GUI of CDM editor 214 after the user has selected the Customer_Measure entity shown in FIG. 5. In response to the selection of the Customer_Measure entity, CDM editor 214 highlights the Customer_Measure entity in the manner shown in FIG. 6. In further response to the selection of the Customer_Measure entity, CDM editor 214 determines the attributes associated with the Customer_Measure entity (through current or previous parsing of the relevant metadata) and displays information about such attributes in a menu of attributes 602. For each attribute, an index number, name, and data format is listed. A data format may be specified in terms of a data type (e.g., string, int64, double, etc.) as shown in FIG. 6 or in terms of a formatting standard (e.g., ISO 8601 for formatting dates, etc.). Thus, references herein to specifying/modifying a data format of an attribute may refer to specifying/modifying a data type associated with the attribute or specifying/modifying a data formatting standard associated with the attribute.

As also shown in FIG. 6, a GUI control 604 labeled “Edit,” a GUI control 606 labeled “Delete,” and a GUI control 608 labeled “{ } JSON” are located at the top of entity menu 502. In an embodiment, CDM editor 214 presents GUI controls 604, 606 and 608 in response to the user selecting an entity from entity menu 502. In an alternate embodiment, CDM editor 214 transitions GUI controls 604, 606 and 608 from being grayed out to solid in response to the user selecting an entity from entity menu 502, which signals to the user that each of these GUI controls may now be interacted with (e.g., clicked on).

The user may click on or otherwise interact with the “Edit” GUI control 604 at the top of entity menu 502 to begin the process of editing the currently selected entity in a guided manner.

The user may click on or otherwise interact with the “Delete” GUI control 606 at the top of entity menu 502 to delete the selected entity. A verification request may be presented to the user before the deletion is carried out.

If a user interacts with the “{ } JSON” control 608 at the top of entity menu 502, then CDM editor 214 will cause the raw JSON associated with the selected entity (in this case, Customer_Measure) to be presented in a window within the GUI of CDM editor 214. The user can directly edit the JSON displayed within this window to modify the entity, as opposed to using the guided menu-driven experience discussed herein. CDM editor 214 may update the JSON shown in the window to reflect changes the user has made via the guided menu-driven experience and, likewise, CDM editor 214 may update the information shown as part of the guided menu-driven experience to reflect changes made to the JSON shown in the window.

As further shown in FIG. 6, an “+Add attribute” GUI control 610 is located at the top of menu of attributes 602. The user may click on or otherwise interact with the “+Add attribute” GUI control 610 to begin the process of adding an attribute to the selected entity.

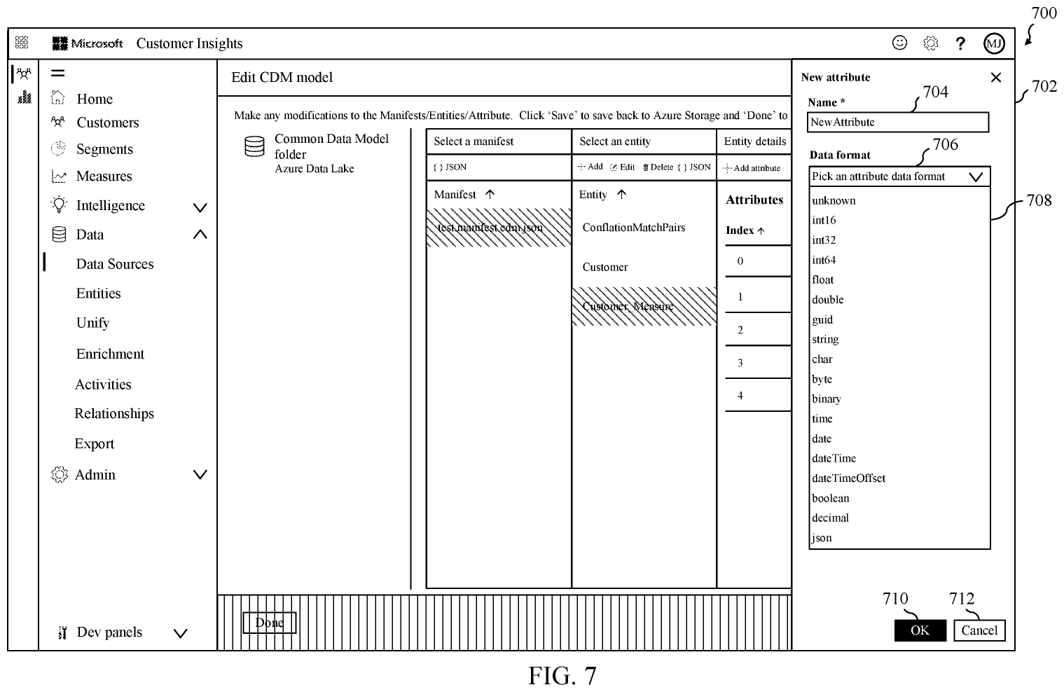

FIG. 7 is a screenshot 700 that shows the state of the GUI of CDM editor 214 after the user has clicked on or otherwise interacted with the “+Add attribute” GUI control 610. As shown in FIG. 7, activation of this control causes a new attribute form (or pane) 702 to appear within the GUI. New attribute form 702 includes a name data entry box 704 via which the user may enter the name of the new attribute and a data format data entry box 706 and associated dropdown menu 708 via which the user may select a data format to be associated with the new attribute. CDM editor 214 may perform syntax checking on the name of the new attribute and flag errors if any are found. Dropdown menu 708 may be configured to only list valid data format types. New attribute form 702 also includes an “OK” button 710 that the user may activate to complete the addition of a new attribute, and a “cancel” button 712 that the user may activate to cancel the process of adding a new attribute.

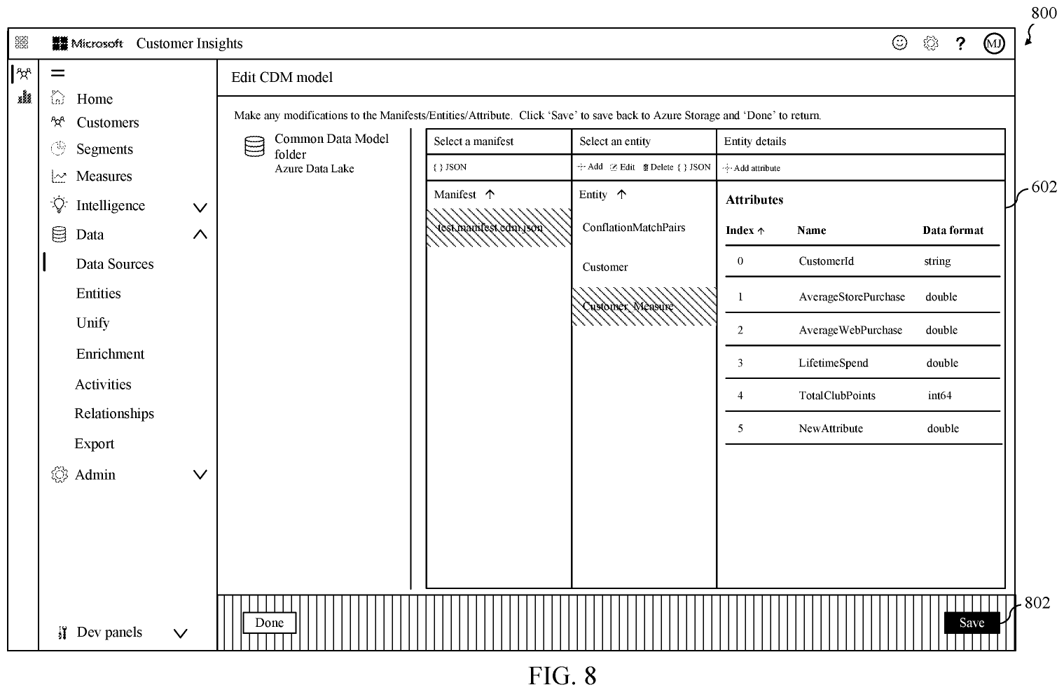

FIG. 8 is a screenshot 800 that shows the state of the GUI of CDM editor 214 after the new attribute NewAttribute has been added to the entity Customer_Measure wherein the NewAttribute attribute has been assigned the index number 5 and the data format “double.” As shown in FIG. 8, this new attribute is now listed at the bottom of menu of attributes 602 associated with the entity Customer_Measure. As also shown in FIG. 8, since the user has modified the data model metadata, a save button 802 on the bottom right of the GUI transitions to a solid state, indicating to the user that the changes can be saved back to data lake 204.

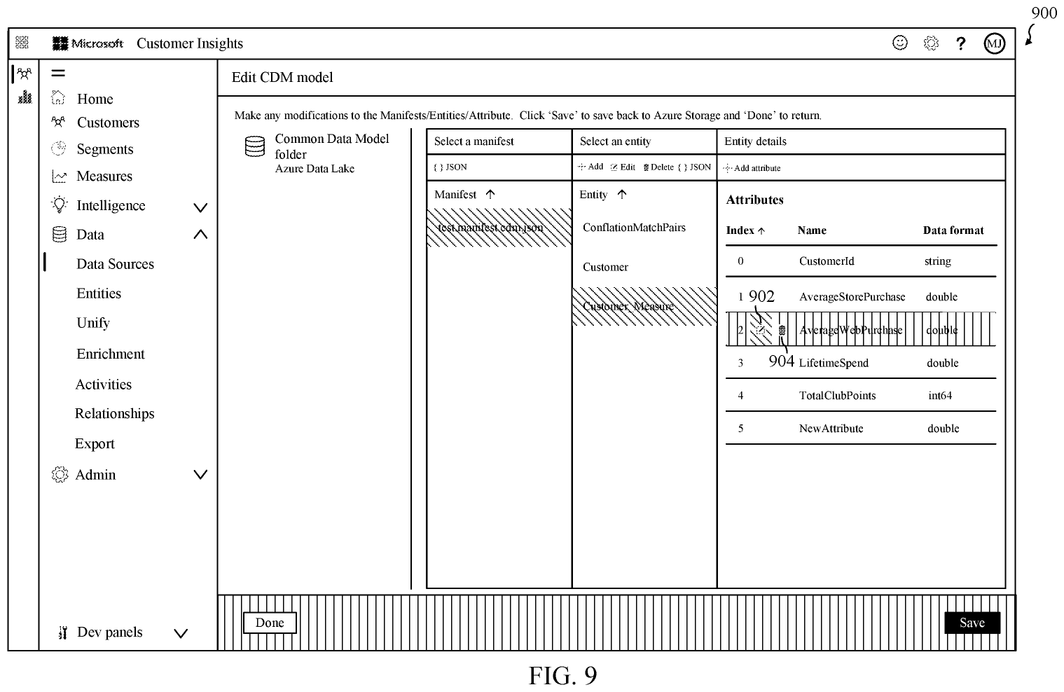

FIG. 9 is a screenshot 900 that shows the state of the GUI of CDM editor 214 when the user is hovering a pointer over a particular attribute in attribute menu 602. In this case, the user is hovering the pointer over the attribute AverageWebPurchase. In response to detecting this hover interaction, CDM editor 214 displays two GUI controls in line with the attribute—an edit GUI control 902 represented by a pencil and a delete GUI control 904 represented by a garbage can. If the user clicks on edit GUI control 902, then the GUI of CDM editor 214 will present the user with a means for editing the attribute. If the user clicks on delete GUI control 904, then the GUI of CDM editor 214 will delete the attribute. A verification request may be presented to the user before the deletion is carried out.

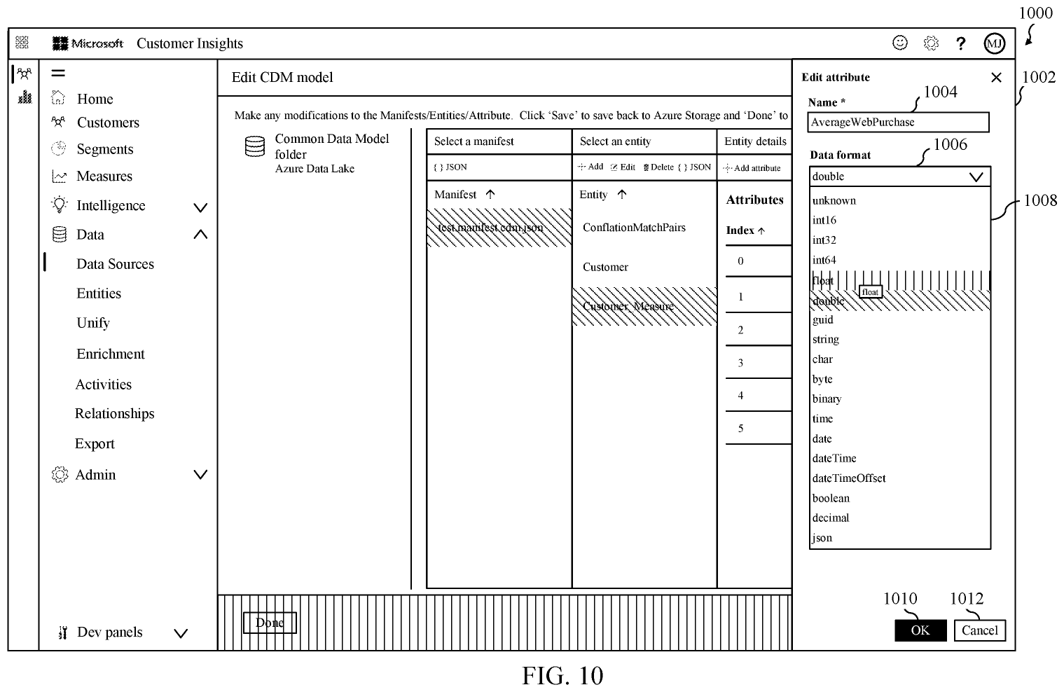

FIG. 10 is a screenshot 1000 that shows the state of the GUI of CDM editor 214 after the user has clicked on or otherwise interacted with edit GUI control 902 for the AverageWebPurchase attribute. As shown in FIG. 10, in response to activation of GUI control 902, CDM editor 214 causes an edit attribute form (or pane) 1002 to appear within the GUI. Edit attribute form 1002 includes a data entry box 1004 that is prepopulated with the current attribute name and via which the user may modify the name of the attribute. CDM editor 214 may perform syntax checking on the modified attribute name and flag errors if any are found. Edit attribute form 1002 also includes a data entry box 1006 that is prepopulated with the current data format and a dropdown menu 1008 via which the user may select a different data format to associated with the attribute. Edit attribute form 1002 also includes an “OK” button 1010 that the user may activate to complete editing the attribute, and a “cancel” button 1012 that the user may activate to abort the process of editing the attribute.

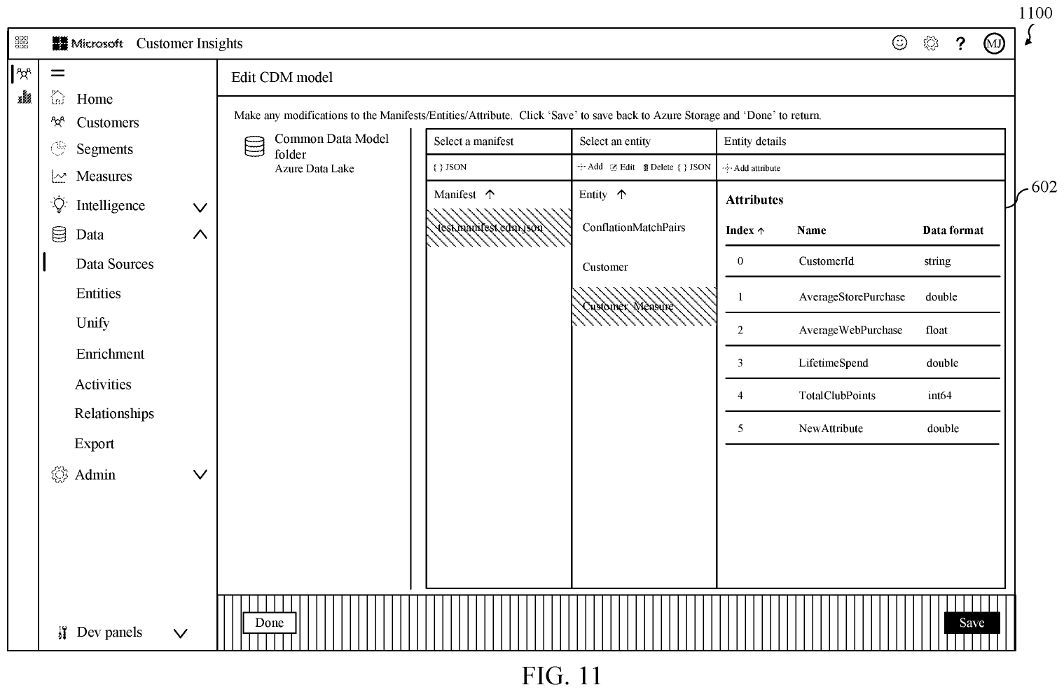

FIG. 11 is a screenshot 1100 shows the state of the GUI of CDM editor 214 after the attribute AverageWebPurchase has been edited such that the data format associated therewith has been changed from “double” to “float.” This new data format for AverageWebPurchase is now shown within attribute menu 602 under the column labeled “data format.”

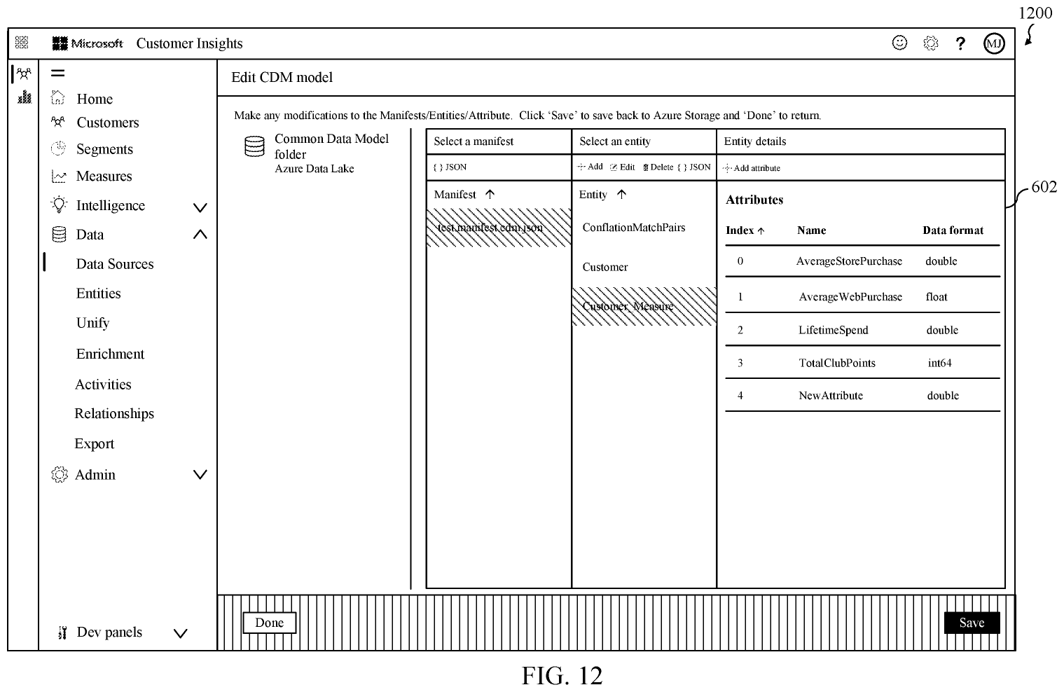

FIG. 12 is a screenshot 1200 that shows the state of the GUI of CDM editor 214 after the user has clicked on or otherwise interacted with a delete GUI control for the CustomerlD attribute, thereby causing that attribute to be deleted. As a result of the deletion, the CustomerlD attribute no longer appears in attribute menu 602, and the index numbers assigned to the attributes have been updated. As noted above, a verification request may be presented to the user before the deletion is carried out.

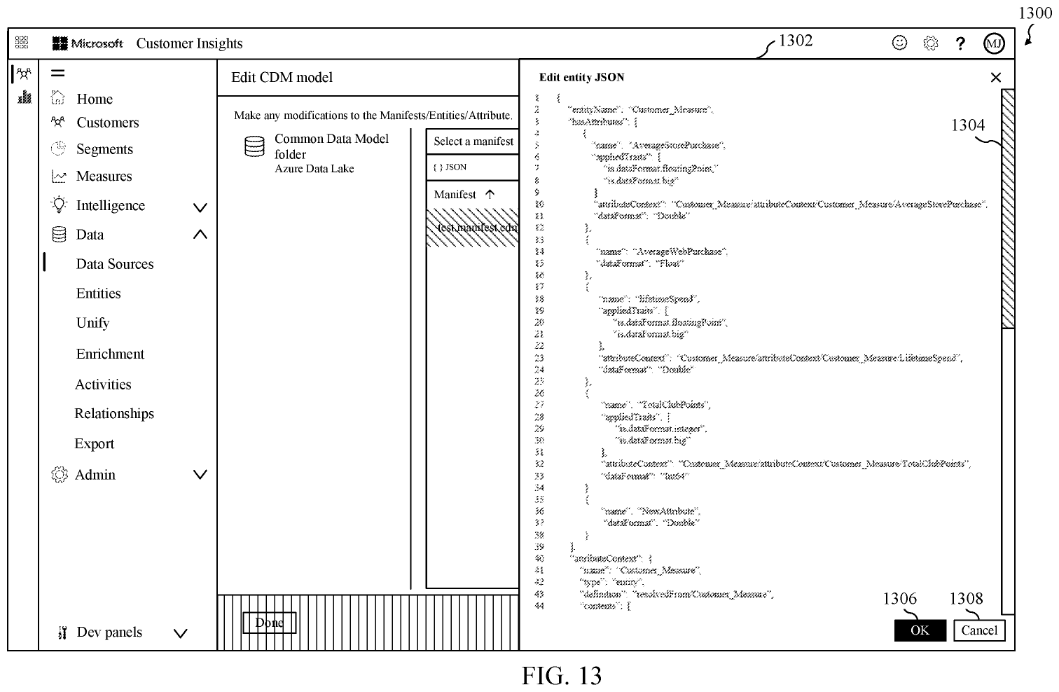

FIG. 13 is a screenshot 1300 that shows the state of the GUI of CDM editor 214 after the user has clicked on or otherwise interacted with “{ } JSON” control 608 at the top of entity menu 502 for the selected Customer_Measure entity. As shown in FIG. 13, as a result of this interaction, CDM editor 214 presents the raw JSON associated with the Customer_Measure entity in a window 1302 within the GUI of CDM editor 214. The user can directly edit the JSON displayed within window 1302 to modify the Customer_Measure entity (including any of its attributes), as opposed to using the guided menu-driven experience discussed herein. Window 1302 includes a scroll bar 1304 that allows the user to scroll up and down through the JSON. Window 1302 includes an OK button 1306 which the user can activate in order to save changes, and a cancel button 1308 which the user can activate in order to cancel changes. CDM editor 214 may update the JSON shown in window 1302 to reflect changes made via the guided menu-driven experience and, likewise, CDM editor 214 may update the information shown as part of the guided menu-driven experience to reflect changes made to the JSON shown in window 1302.

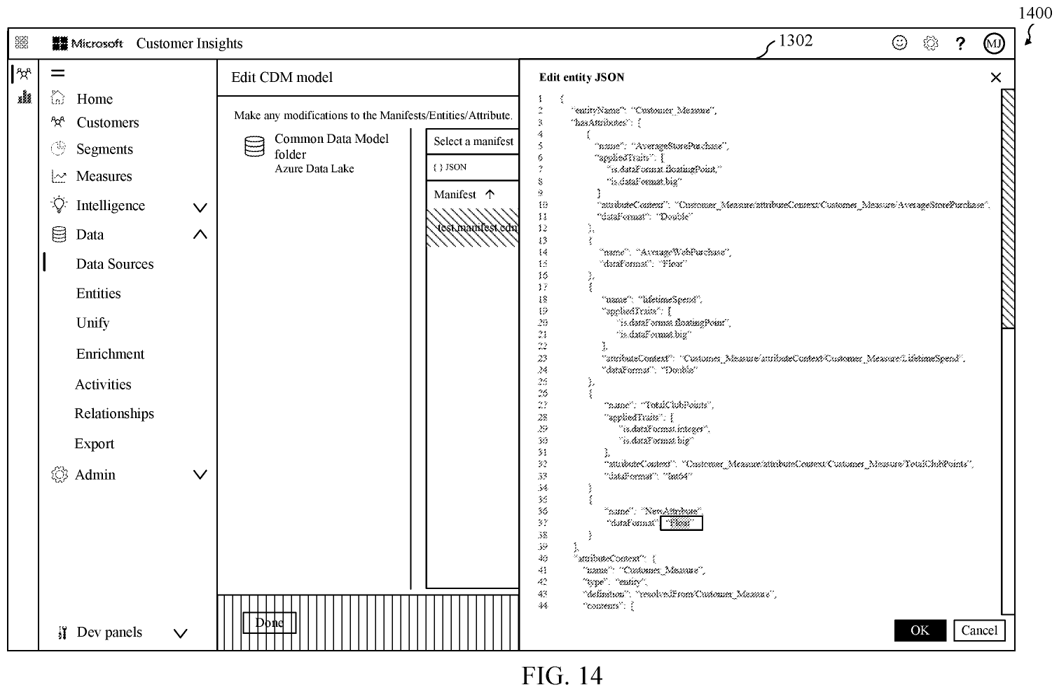

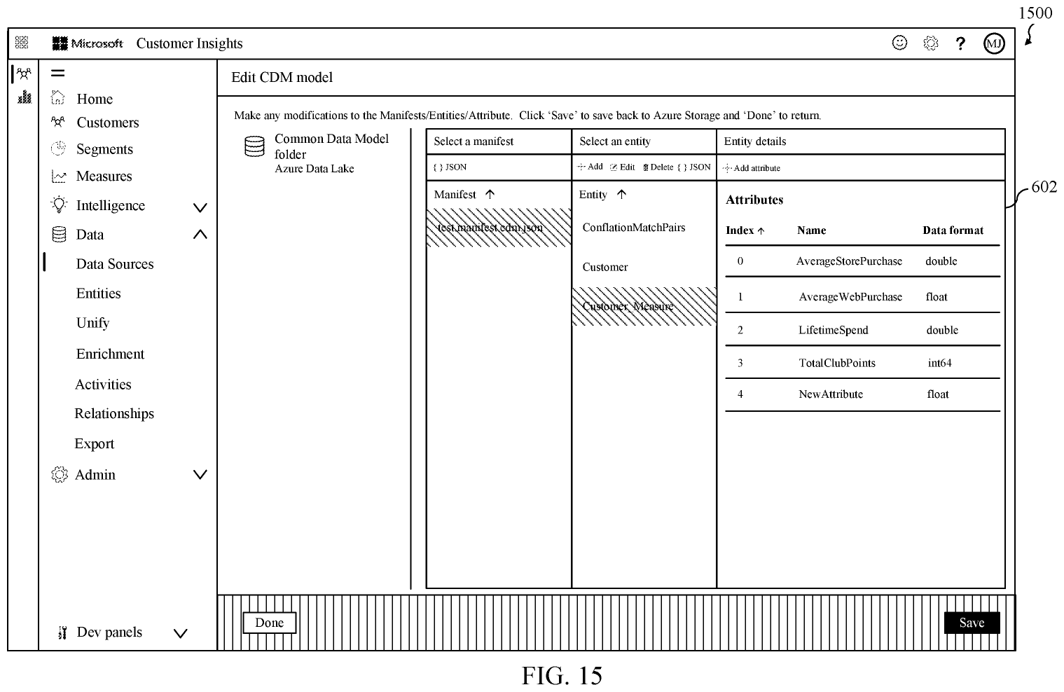

FIG. 14 is a screenshot 1400 of the GUI of CDM editor 214 that highlights that the attribute NewAttribute that was previously added via the guided menu-driven experience (as discussed above) and its associated data format that was modified via the guided menu-driven experience (as discussed above) are now reflected in the raw JSON for the entity Customer_Measure shown in window 1302. FIG. 15 is a screenshot 1500 of the GUI of CDM editor 214 that shows that the data format for the attribute NewAttribute is also reflected in attribute menu 602.

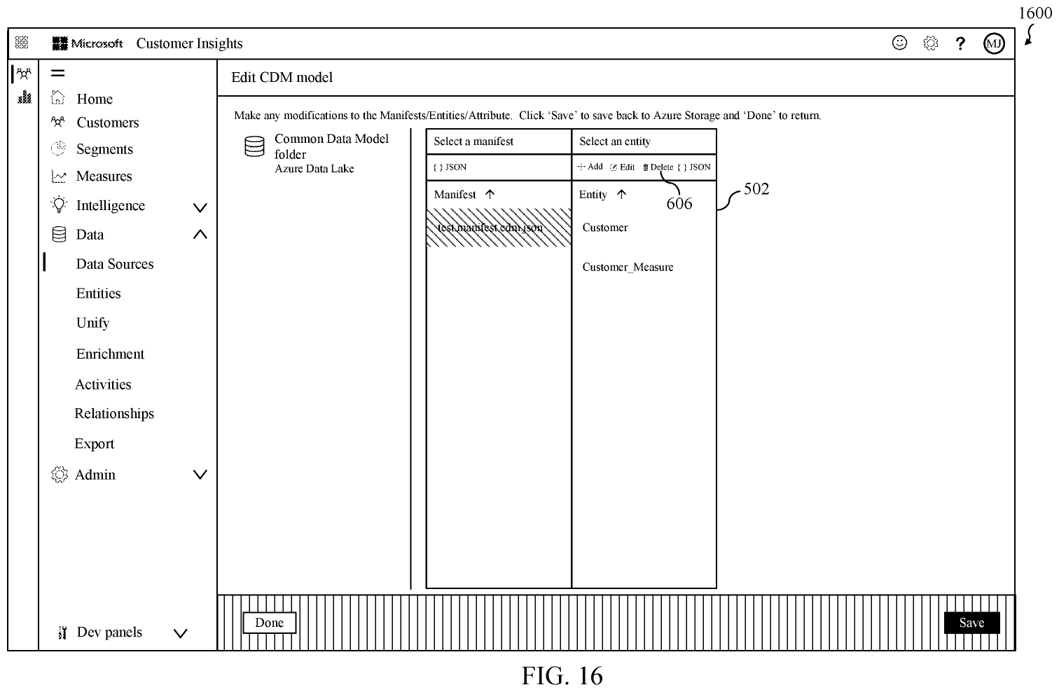

FIG. 16 is a screenshot 1600 that shows the state of the GUI of CDM editor 214 after the user has clicked on or otherwise interacted with “delete” GUI control 606 at the top of entity menu 502 while the entity ConflationMatchPairs was selected. As a result, CDM editor 214 has deleted the entity ConflationMatchPairs from the metadata and also removed the entity from entity menu 502. As noted above, a verification request may be presented to the user before the deletion is carried out.

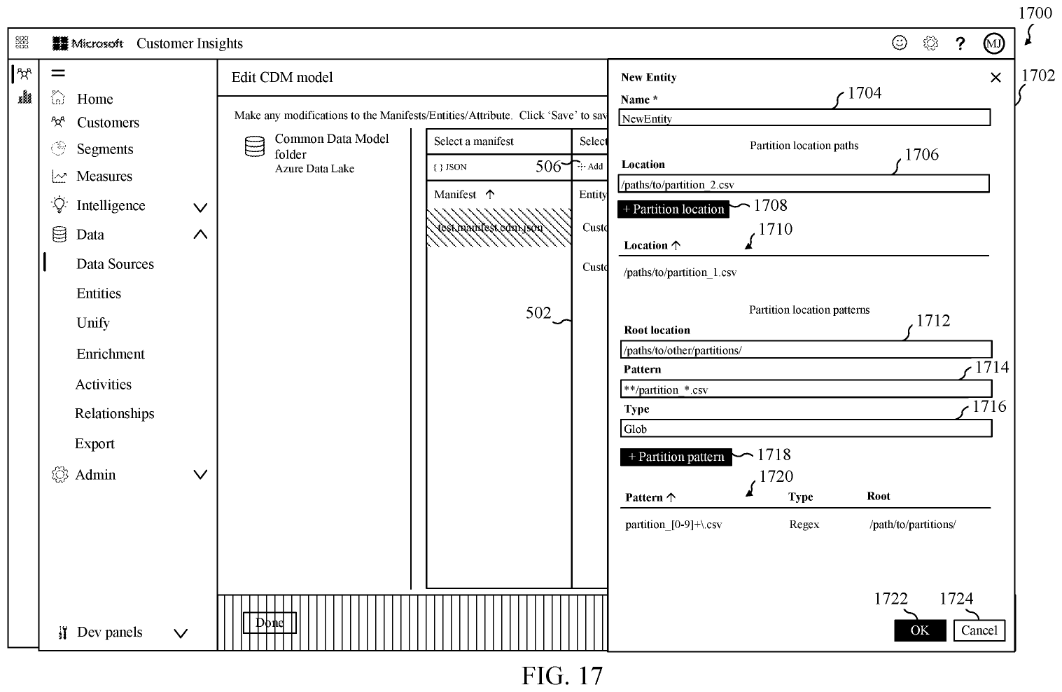

FIG. 17 is a screenshot 1700 that shows the state of the GUI of CDM editor 214 after the user has clicked on “+Add” GUI control 506 at the top of entity menu 502. As shown in FIG. 7, activation of GUI control 506 causes a new entity form (or pane) 1702 to appear within the GUI. New entity form 1702 includes a name data entry box 1704 via which the user may enter the name of the new entity. CDM editor 214 may perform syntax checking on the name of the new attribute and flag errors if any are found.

New entity form 1702 also includes a location data entry box 1706 via which the user can specify a location to be included in the new entity metadata. The location comprises a path and filename at which a data file (also referred to as a partition) associated with the entity may be found. New entity form 1702 further includes a “+ Partition location” button 1708 that the user may interact with to cause CDM editor 214 to add a location specified in location data entry box 1706 to the CDM metadata for the new entity. CDM editor 214 displays a list 1710 of partition locations that have been added for the new entity within new entity form 1702. In an embodiment, CDM editor 214 may validate a location added by the user by determining if the path and file exist prior to adding such location to the entity metadata. For example, CDM editor 214 may only allow a location to be added if both the path and file exist, in which case the location will be shown in list 1710; if the path and/or file do not exist, then CDM editor 214 may return an error message to the user.

As further shown in FIG. 17, new entity form 1702 further includes a root location data entry box 1712, a pattern data entry box 1714, and a type data entry box 1716 via which a user can specify patterns (regular expressions) to be included in the new entity metadata. Such patterns are used to locate through pattern matching data files associated with the entity. New entity form 1702 further includes a “+ Partition pattern” button 1718 that the user may interact with to cause CDM editor 214 to add a partition pattern that has been specified via data entry boxes 1712, 1714, and 1716 to the CDM metadata for the new entity. CDM editor 214 displays a list 1720 of partition location patterns that have been added for the new entity within new entity form 1702. In an embodiment, CDM editor 214 can validate the locations and/or regular expressions and identify potential problems to the user (e.g., invalid paths, invalid patterns, and/or missing files). With respect to location patterns, CDM editor 214 can display a list of data files that currently match the pattern, so that the user can verify that desired data files are being targeted.

New entity form 1702 also includes an “OK” button 1722 that the user may activate to complete the addition of the new entity, and a “cancel” button 1724 that the user may activate to cancel the process of adding a new entity.

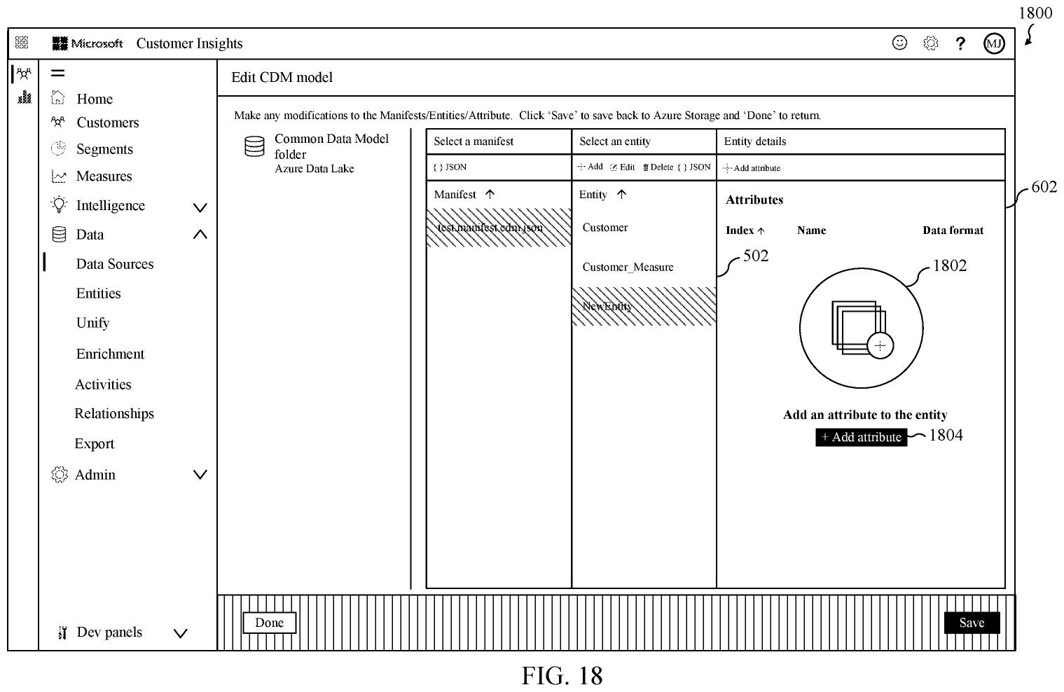

FIG. 18 is a screenshot 1800 that shows the state of the GUI of CDM editor 214 after the has added the entity NewEntity to the manifest. As shown in FIG. 18, the entity NewEntity now appears at the bottom of entity menu 502 and has been selected by the user. However, since there are no attributes yet associated with NewEntity, attribute menu 602 is occupied by an add attribute image 1802 and “+Add attribute” button 1804. The user can activate button 1804 to be guided through the process of adding new attributes to the entity NewEntity.

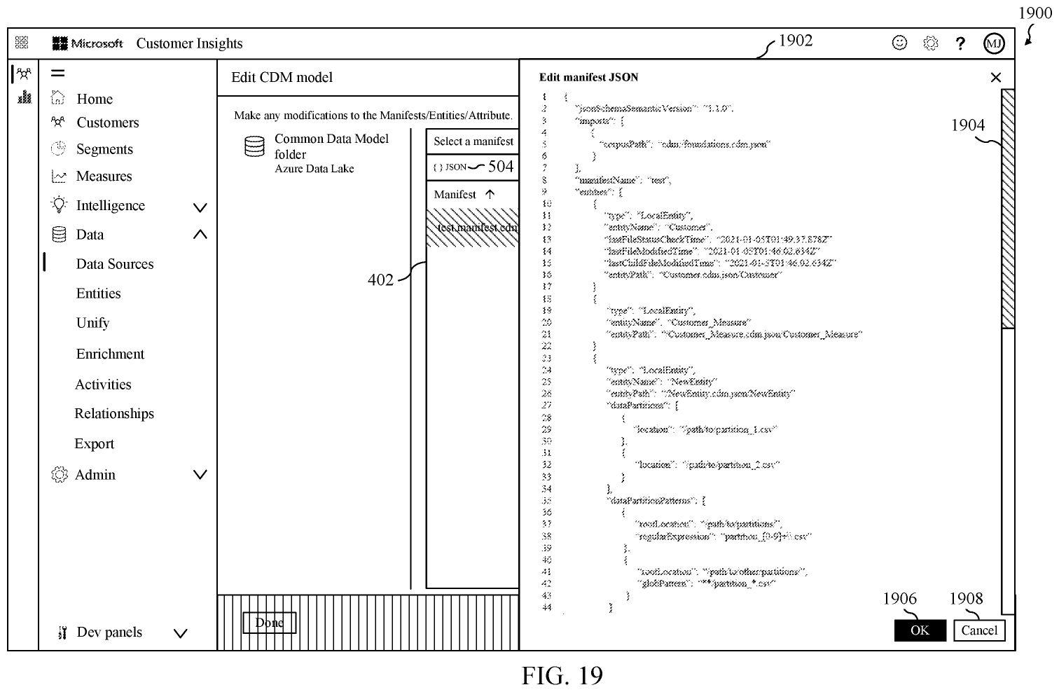

FIG. 19 is a screenshot 1900 that shows the state of the GUI of CDM editor 214 after the user has clicked on or otherwise interacted with “{ } JSON” control 504 at the top of manifest menu 402 for the selected manifest test.manifest.cdm.json. As shown in FIG. 19, as a result of this interaction, CDM editor 214 presents the raw JSON associated with the manifest test.manifest.cdm.json in a window 1902 within the GUI of CDM editor 214. The user can directly edit the JSON displayed within window 1902 to modify the manifest test.manifest.cdm.json, as opposed to using the guided menu-driven experience discussed herein. Window 1902 includes a scroll bar 1904 that allows the user to scroll up and down through the JSON. Window 1902 includes an OK button 1906 which the user can activate in order to save changes, and a cancel button 1908 which the user can activate in order to cancel changes. CDM editor 214 may update the JSON shown in window 1902 to reflect changes made via the guided menu-driven experience and, likewise, CDM editor 214 may update the information shown as part of the guided menu-driven experience to reflect changes made to the JSON shown in window 1902.

As shown in FIG. 19, the entity NewEntity that was created via the guided menu-driven experience has automatically been reflected in the raw JSON of the manifest test.manifest.cdm.json displayed within window 1902.

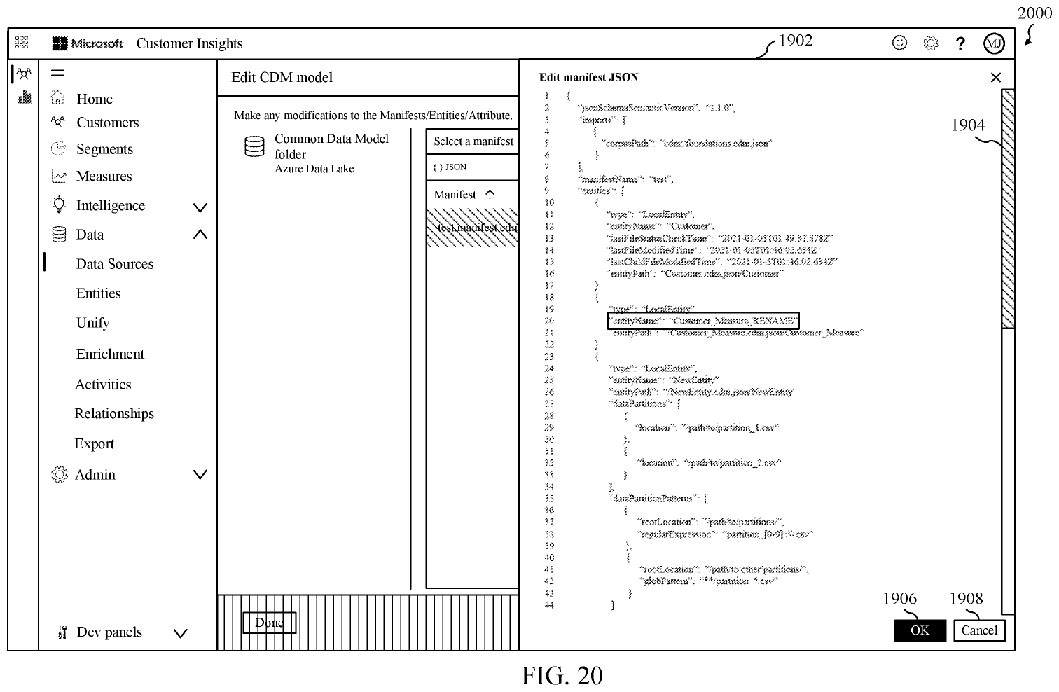

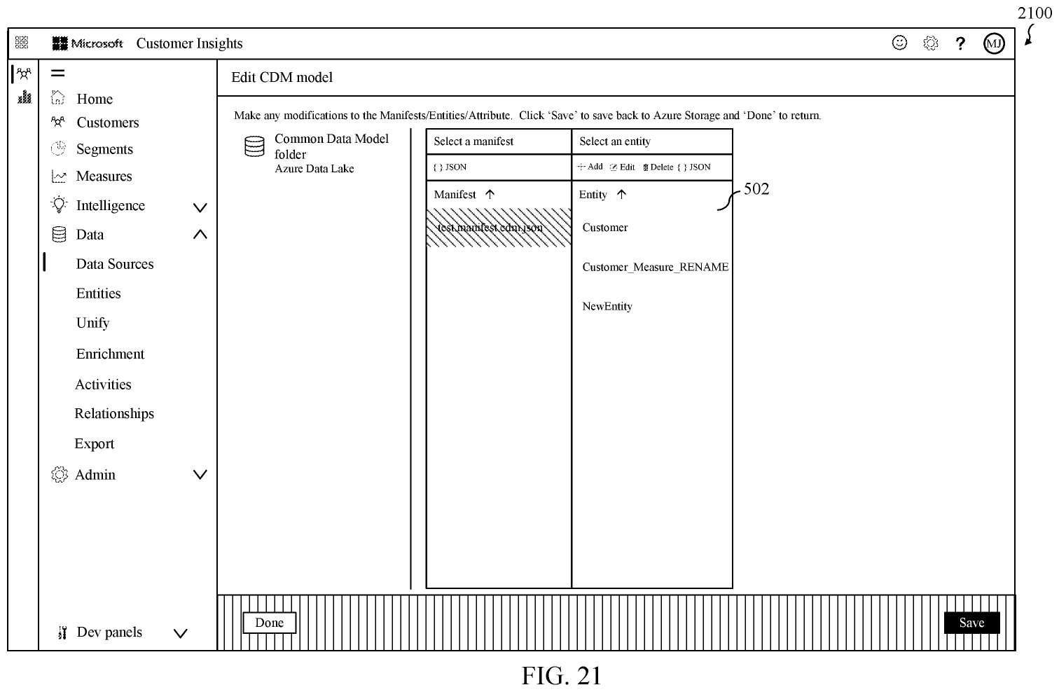

FIG. 20 is a screenshot 2000 that shows the state of the GUI of CDM editor 214 after the user has edited the raw JSON of the manifest test.manifest.cdm.json to change the name of an entity from Customer_Measure to Customer_Measure_RENAME. After the user has saved the change by activating “OK” button 1906, the entity name change is reflected in entity menu which forms part of the guided menu-driven experience, as shown in FIG. 21. In particular, as shown in screenshot 2100 of FIG. 21, the modified entity name Customer_Measure_RENAME now appears in entity menu 502.

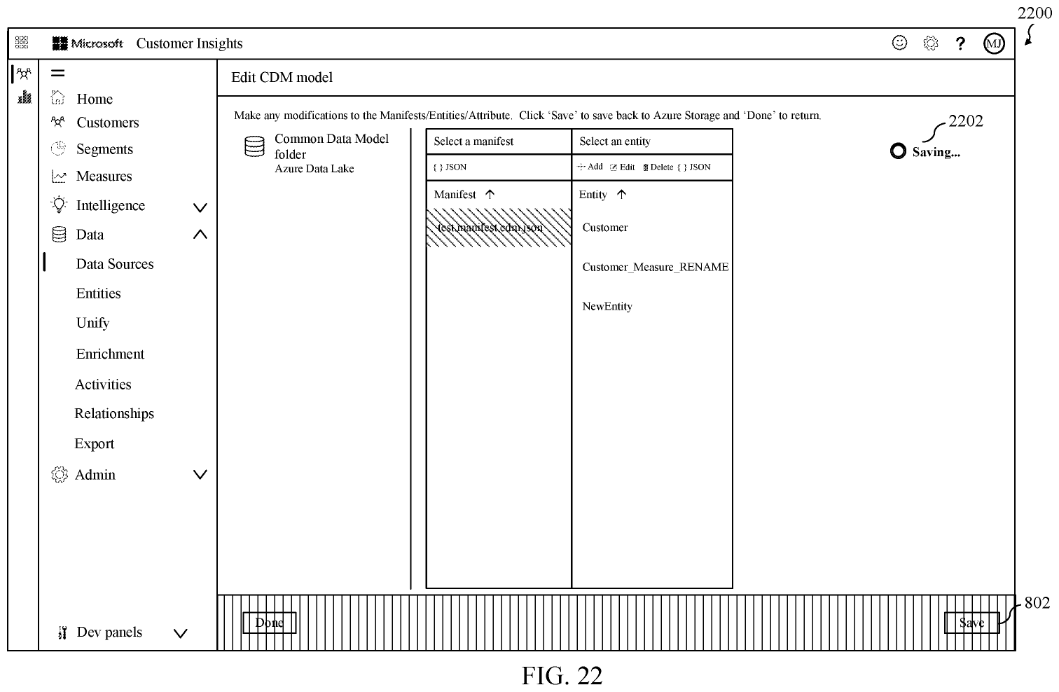

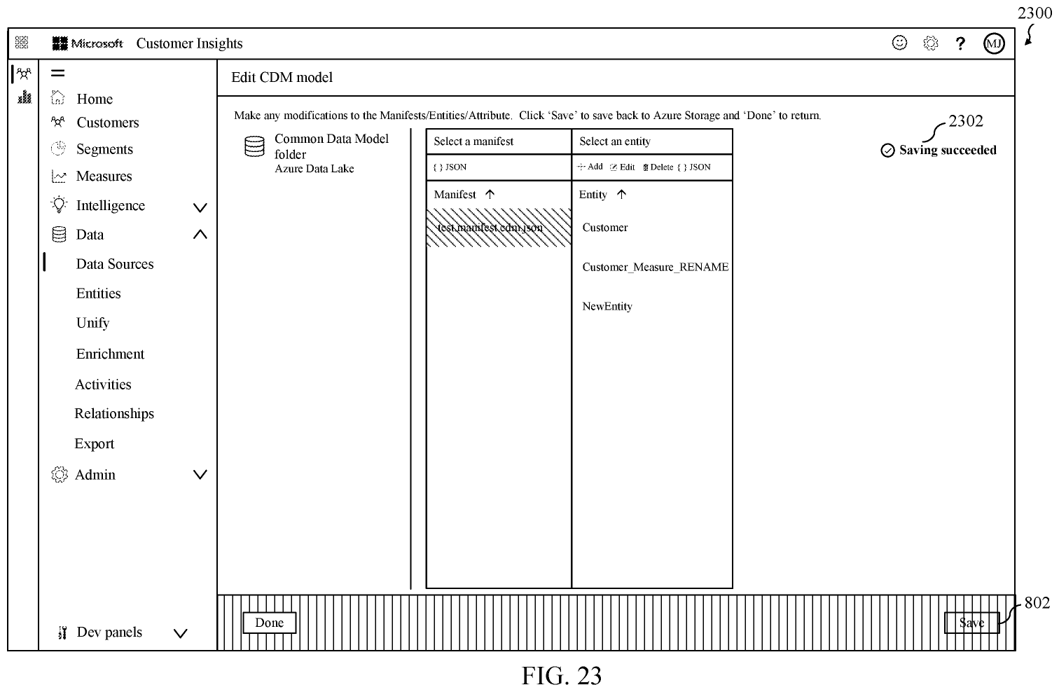

FIG. 22 is a screenshot 2200 that shows the state of the GUI of CDM editor 214 after the user has clicked on “save” button 802 on the bottom right of the screen. In response to this interaction, CDM editor 214 stores the updated metadata files (e.g., updated versions of test.manifest.cdm.json and the *.cdm.json files), which exist in a parsed, interpreted form in local memory, back to data lake 204. While this process is occurring, the message “Saving . . . ” appears 2202 in the GUI of CDM editor 214. FIG. 23 is a screenshot 2300 that shows the state of the GUI of CDM editor 214 after the save operation is complete, in which case the GUI of CDM editor 214 displays the message “Saving Succeeded” 2302 and grays out “save” button 802 since there are no pending changes to be saved. Once CDM editor 214 has saved the updated data model metadata files, the user may then use CDM attach utility 212 to cause the customer data platform to ingest the customer data included in CDM folder 218 using the revised metadata files.

In an embodiment, CDM editor 214 enables a user to apply the currently edited version of the metadata (which as noted above exists in an interpreted form in local memory) to some or all of the data from one or more data files associated with the metadata, after which CDM editor 214 presents the user with visual feedback. For example, CDM editor 214 can apply a data schema associated with an entity to a sample of data from a data file associated with that entity and present the results to the user in a portion of (e.g., a window or panel within) the GUI of CDM editor 214. Thus, for example, the CDM editor 214 can present within the GUI a table showing how the attributes of the entity (as defined by the metadata) have been mapped to the data elements within the data sample to assist the user in determining if the data schema is correctly aligned with the underlying data.

As noted above, data model metadata associated with a CDM folder may exist in one file or may be distributed across multiple inter-related files. CDM editor 214 is capable of determining relationships (including but not limited to dependencies) between files and metadata elements (e.g., entities, attributes, etc.) referenced in such files and to update multiple files and/or metadata elements as necessary in order to implement a metadata change made by a user via CDM editor 214 described herein. This feature of CDM editor 214 makes creating and modifying the CDM metadata a far less intimidating and error-prone process for users.

In an embodiment, CDM editor 214 may be configured to present the user with automatic schema suggestions based, e.g., on an analysis of the files associated with the CDM folder for which metadata is being created/edited. For example, CDM editor 214 may be configured to recommend one or more of a manifest name, an entity name, an attribute name, an attribute data format, an entity location, an entity location pattern, or the like, based on analysis of the files associated with the CDM folder for which metadata is being created/edited.

In a further embodiment, CDM editor 214 may be configured to enable the user to transform data stored in the data files associated with the CDM metadata. For example, CDM editor 214 may present the user with one or more GUI controls that enables the user to apply transformations to the data that may include, for example, merging columns, formatting columns, clearing spaces, or the like.

In view of the foregoing it can be seen that aforementioned CDM editor may be configured to provide at least the following advantages/benefits: (1) enables users to seamlessly create and modify CDM metadata files through a “what-you-see-is-what-you-get” (WYSIWYG) interface; (2) provides syntax checking and validation of user input and selections made when creating or modifying CDM metadata; (3) enables changes to be made via both a guided menu-driven user interface and through an editing window that permits directed editing of metadata JSON, and reflects changes across both interfaces; (4) provides immediate visual feedback to the user concerning the impact of metadata changes (e.g., a list of data files targeted by a location or location pattern, a representation of how a data schema maps to a sample of data); and (5) provides automatic schema suggestions.

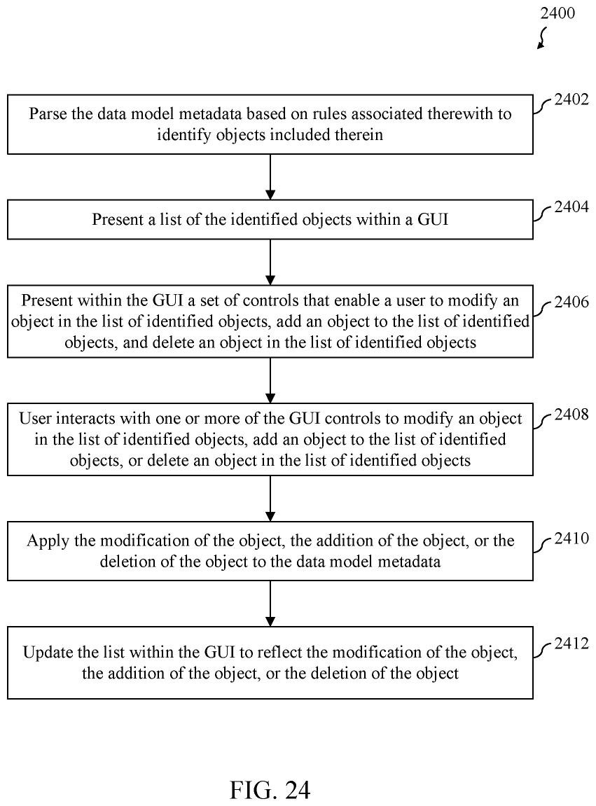

FIG. 24 depicts a flowchart 2400 of a computer-implemented method for creating or modifying data model metadata associated with data stored in one or more data files. The method of flowchart 2400 may be performed, for example, by a data model metadata editor such as CDM editor 214 as described above and, for the sake of illustration, will be now be described with continued reference to CDM editor 214. However, the method is not limited to such an implementation and may be implemented by other entities entirely. Furthermore, the order of steps shown in flowchart 2400 does not necessarily imply a strict temporal sequence and various steps may occur concurrently or in a different order than that shown.

As shown in FIG. 24, the method of flowchart 2400 begins at step 2402, in which CDM editor 214 parses the data model metadata based on rules associated therewith to identify objects included therein. For example, CDM editor 214 may parse the data model metadata stored in CDM folder 218 (e.g., in a *.model.json file or in *manifest.cdm.json/*.cdm.json files stored in CDM folder 218) to identify objects included therein. The objects may include, for example, a manifest, one or more entities, one or more attributes associated with an entity, one or more entity partition locations, and one or more entity partition location patterns. After parsing the data model metadata, CDM editor 214 may maintain a parsed, interpreted form of the data model metadata in system memory of a computing device upon which CDM editor 214 is executing. CDM editor 214 may also store a copy of the raw data model metadata itself in system memory to enable the user to directly edit such data model metadata.

At step 2404, CDM editor 214 presents a list of the identified objects within the GUI of CDM editor 214. For example, CDM editor 214 may present a list of identified entities within entity menu 502 of the GUI of CDM editor 214 as shown in FIG. 5 or may present a list of identified attributes of an entity within attribute menu 602 of the GUI of CDM editor 214 as shown in FIG. 6, although these are only examples. CDM editor 214 may also be configured to present a list of identified entity partition locations and/or a list of identified entity partition location patterns within the GUI.

At step 2406, CDM editor 214 presents within the GUI a set of controls that enable a user to modify an object in the list of identified objects, add an object to the list of identified objects, and delete an object in the list of identified objects. For example, with continued reference to FIGS. 5, 6 and 9, CDM editor 214 may present within the GUI each of the following: GUI control 506 that enables the user to add an entity, GUI control 604 that enables the user to edit an entity, GUI control 606 that enables the user to delete an entity, GUI control 610 that enables the user to add an attribute, GUI control 902 that enables the user to edit an attribute, and GUI control 904 that enables the user to delete an attribute. CDM editor 214 may also present GUI controls that enable the user to add, delete or modify entity partition locations and/or entity partition location patterns.

At step 2408, a user of CDM editor 214 interacts with one or more of the GUI controls to modify an object in the list of identified objects, add an object to the list of identified objects, or delete an object in the list of identified objects. For example, the user may interact with any of the aforementioned GUI controls of CDM editor 214 to add, modify or delete an entity, an attribute of an entity, an entity partition location, or an entity partition location pattern. By way of example, the discussion of FIG. 7 above describes the process for adding an attribute, the discussion of FIG. 10 above describes the process for editing an attribute, the discussion of FIG. 12 above describes the process for deleting an attribute, and the discussion of FIG. 17 above describes the process for adding an entity, an entity partition location, and an entity partition location pattern.

At step 2410, in response to the user interaction with the one or more of the GUI controls to modify an object in the list of identified objects, add an object to the list of identified objects, or delete an object in the list of identified objects, CDM editor 214 applies the modification of the object, the addition of the object, or the deletion of the object to the data model metadata. For example, CDM editor 214 may apply the modification of the object, the addition of the object, or the deletion of the object to the locally-stored copy of the data model metadata, which can then be saved back to data lake 204 by clicking on “save” button 802. CDM editor 214 may apply the modification of the object, the addition of the object, or the deletion of the object to the data model metadata by updating a plurality of inter-related data model metadata files, such as one or more *.manifest.cdm.json files and/or one or more *.cdm.json files.

At step 2412, in further response to the user interaction with the one or more of the GUI controls to modify an object in the list of identified objects, add an object to the list of identified objects, or delete an object in the list of identified objects, CDM editor 214 updates the list within the GUI to reflect the modification of the object, the addition of the object, or the deletion of the object. For example, CDM editor 214 may update entity menu 502 of the GUI of CDM editor 214 to reflect the addition, modification or deletion of an entity and may update attribute menu 602 of the GUI of CDM to reflect the addition, modification, or deletion of an attribute as was previously described. CDM editor 214 may likewise be configured to update a list of entity partition locations or a list of entity partition location patterns to reflect an addition/modification/deletion.

In an embodiment, the method of flowchart 2400 may further include presenting within the GUI of CDM editor 214 a value of a property associated with each of the identified objects. For example, the property may comprise one of a manifest name (e.g., test.manifest.cdm.json as shown in manifest menu 402 of FIG. 4), an entity name (e.g., ConflationMatchPairs, Customer, and Customer_Measure as shown in entity menu 502 of FIG. 5), an attribute name (e.g., Customerld, AverageStorePurchase, AverageWebPurchase, LifetimeSpend, and TotalClubPoints as shown in attribute menu 602 of FIG. 6), an attribute data format (e.g., the various data formats associated with the various attributes shown in attribute menu 602 of FIG. 6), a location of a partition location path (e.g. location “/paths/to/partition_1.csv” shown in list 1710 of FIG. 17), or a root location, pattern or type of a partition location pattern (e.g., see list 1720 of FIG. 17).

In a further embodiment, the method of flowchart 2400 may further include enabling the user to assign a value to a property of one of the identified objects or of an object to be added to the list of identified objects by only allowing the user to select from among a set of valid values for the property as specified by the rules associated with the data model metadata. For example, as discussed above in reference to FIG. 7, the user may be enabled to assign a value to a data format of a new attribute by only allowing the user to select from among a set of valid data format values as presented within dropdown menu 708. A similar concept is shown in FIG. 10 with respect to modifying the value of a data format associated with an existing attribute.

In another embodiment, the method of flowchart 2400 further comprises enabling the user to input a value of a property of one of the identified objects or of an object to be added to the list of identified objects and, responsive to the user inputting the value of the property, performing one or more of syntax checking the value or validating the value based on the rules associated with the data model metadata. For example, as discussed above, CDM editor 214 may perform syntax checking or validation of values of properties input by the user pursuant to adding or modifying an entity or attribute.

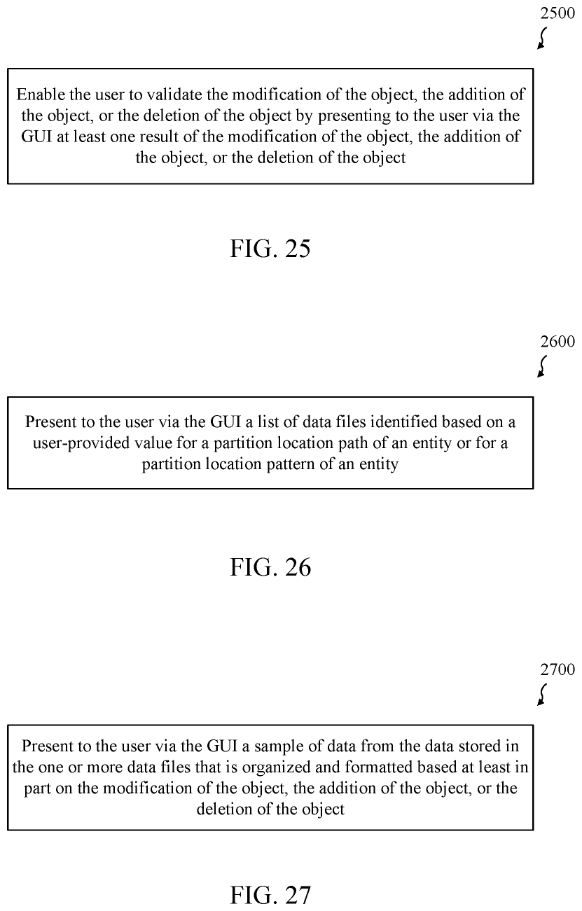

FIG. 25 shows an additional step 2500 that may be performed as part of the computer-implemented method 2400 for creating or modifying data model metadata associated with data stored in one or more data files. Like the steps of flowchart 2400, step 2500 may be performed by CDM editor 214 as described above. However, the step is not limited to such an implementation and may be implemented by other entities entirely. As shown in FIG. 25, step 2500 comprises enabling the user to validate the modification of the object, the addition of the object, or the deletion of the object by presenting to the user via the GUI at least one result of the modification of the object, the addition of the object, or the deletion of the object.

One manner in which step 2500 may be carried out is shown as step 2600 of FIG. 26. As shown in FIG. 26, step 2600 comprises presenting to the user via the GUI a list of data files identified based on a user-provided value for a partition location path of an entity or for a partition location pattern of an entity. Thus, for example, CDM editor 214 may be configured to respond to a user addition or modification of a partition location path of an entity (e.g., as part of a process of adding or editing an entity) by displaying a list of data files (e.g., data files in data lake 204) that are stored at the added/updated partition location path within the GUI of CDM editor 214. Likewise, CDM editor 214 may be configured to respond to a user addition or modification of partition location pattern of an entity (e.g., as part of a process of adding or editing an entity) by displaying a list of data files (e.g., data files in data lake 204) that match such partition location pattern within the GUI of CDM editor 214. This advantageously enables the user to ascertain via the GUI of CDM editor 214 whether the user-provided partition location path or partition location pattern is targeting desired data files, prior to saving the data model metadata changes and prior to data ingestion to customer data platform 202.

Another manner in which step 2500 may be carried out is shown as step 2700 of FIG. 27. As shown in FIG. 27, step 2700 comprises presenting to the user via the GUI a sample of data from the data stored in the one or more data files that is organized and formatted based at least in part on the modification of the object, the addition of the object, or the deletion of the object. Thus, for example, CDM editor 214 may be configured to respond to a user addition or modification of an attribute of an entity (e.g., as part of a process of adding, editing, or deleting an attribute) by displaying within the GUI a table showing how the attributes of the entity (as defined by the metadata) have been mapped to data elements within the data sample. This advantageously enables the user to ascertain via the GUI of CDM editor 214 whether the data schema for the entity is correctly aligned with the underlying customer data, prior to saving the data model metadata changes and prior to data ingestion to customer data platform 202.

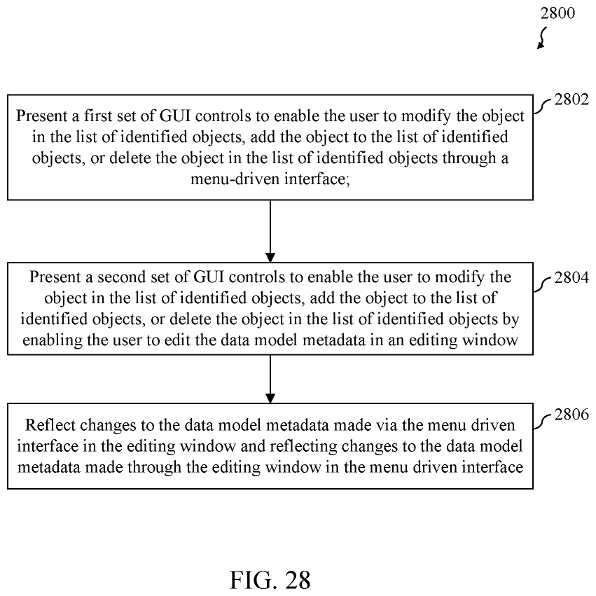

FIG. 28 depicts a flowchart 2800 of additional steps that may be performed as part of the computer-implemented method 2400 for creating or modifying data model metadata associated with data stored in one or more data files. The method of flowchart 2800 may be performed, for example, by a data model metadata editor such as CDM editor 214 as described above and, for the sake of illustration, will be now be described with continued reference to CDM editor 214. However, the steps of flowchart 2800 are not limited to such an implementation and may be implemented by other entities entirely. Furthermore, the order of steps shown in flowchart 2800 does not necessarily imply a strict temporal sequence and various steps may occur concurrently or in a different order than that shown.

As shown in FIG. 28, the steps of flowchart 2800 begin at step 2802, in which CDM editor 214 presents a first set of GUI controls to enable the user to modify the object in the list of identified objects, add the object to the list of identified objects, or delete the object in the list of identified objects through a menu-driven interface. Thus, as described above, CDM editor 214 presents a variety of controls that enable the user to modify entities and attributes via a menu driven interface. With continued reference to FIGS. 5, 6 and 9, these controls include but are not limited to GUI control 506 that enables the user to add an entity via a menu-driven interface, GUI control 604 that enables the user to edit an entity via a menu-driven interface, GUI control 606 that enables the user to delete an entity via a menu-driven interface, GUI control 610 that enables the user to add an attribute via a menu-driven interface, GUI control 902 that enables the user to edit an attribute via a menu-driven interface, and GUI control 904 that enables the user to delete an attribute via a menu-driven interface. CDM editor 214 may also present GUI controls that enable the user to add, delete or modify entity partition locations and/or entity partition location patterns via a menu-driven interface.

In step 2804, CDM editor 214 presents a second set of GUI controls to enable the user to modify the object in the list of identified objects, add the object to the list of identified objects, or delete the object in the list of identified objects by enabling the user to edit the data model metadata in an editing window. Thus, as described above, CDM editor 214 presents a variety of controls that enable the user to modify a manifest, entities, and attributes by directly editing the raw (unparsed and uninterpreted) data model metadata in an editing window. With continued reference to FIGS. 5, 6, 13, and 19 these controls include but are not limited to “{ } JSON” GUI control 504 that enables the user to edit manifest JSON directly in window 1902 and “{ } JSON” GUI control 608 that enables the user to edit entity JSON directly in window 1302.

In step 2806, CDM editor 214 reflects changes to the data model metadata made via the menu driven interface in the editing window and reflects changes to the data model metadata made through the editing window in the menu driven interface. Thus, as described above, CDM editor 214 is configured to reflect any changes made to entities and attributes via the menu-driven interface in the editing windows that display manifest and entity JSON and likewise is configured to reflect any changes made to entities and attributes via the editing windows in the menu-driven interface.

In an embodiment, the method of flowchart 2400 may further include presenting data model metadata suggestions via the GUI. For example, CDM editor 214 may be configured to present suggested property values to a user pursuant to the user adding or updating an entity or attribute. The suggested property values may comprise one or more of: a suggested manifest name; a suggested entity name; a suggested entity partition location path; a suggested entity partition location pattern; a suggested attribute name; or a suggested attribute data format. In an embodiment, CDM editor 214 may be configured to analyze one or more of the metadata files in CDM folder 218 (e.g., *.model.json, one or more *.manifest.cdm.json files, and/or one or more *.cdm.json files) to determine suggested property values.

In the foregoing description, the data model metadata that is edited using CDM editor 214 is Common Data Model (CDM) metadata. However, the techniques described herein are equally applicable to editing metadata associated with any data model that organizes elements of data and standardizes how they relate to one another and to the properties of real-world entities. Furthermore, although the data model metadata described herein is formatted in accordance with JavaScript Object Notation (JSON), it is to be understood that such data model metadata may be represented using any of a wide variety of formats, including other data interchange formats such as Extensible Markup Language (XML) or Comma-Separated Values (CSV).

### III. Example Computer System Implementation

Each of customer data platform 202, CDM attach utility 212, CDM editor 214, other customer data platform functionality 216, and data lake 204 of FIG. 2, the customer data platform GUI of FIG. 3, the CDM editor GUI of FIGS. 4-23, the method of flowchart 2400 of FIG. 24, step 2500 of FIG. 25, step 2600 of FIG. 26, step 2700 of FIG. 27 and the steps of flowchart 2800 of FIG. 28 may be implemented in hardware, or hardware combined with software and/or firmware. For example, each of customer data platform 202, CDM attach utility 212, CDM editor 214, other customer data platform functionality 216, and data lake 204 of FIG. 2, the customer data platform GUI of FIG. 3, the CDM editor GUI of FIGS. 4-23, the method of flowchart 2400 of FIG. 24, step 2500 of FIG. 25, step 2600 of FIG. 26, step 2700 of FIG. 27 and the steps of flowchart 2800 of FIG. 28 may be implemented as computer program code/instructions configured to be executed in one or more processors and stored in a computer readable storage medium. Alternatively, each of customer data platform 202, CDM attach utility 212, CDM editor 214, other customer data platform functionality 216, and data lake 204 of FIG. 2, the customer data platform GUI of FIG. 3, the CDM editor GUI of FIGS. 4-23, the method of flowchart 2400 of FIG. 24, step 2500 of FIG. 25, step 2600 of FIG. 26, step 2700 of FIG. 27 and the steps of flowchart 2800 of FIG. 28 may be implemented as hardware logic/electrical circuitry.

For instance, in an embodiment, one or more, in any combination, of customer data platform 202, CDM attach utility 212, CDM editor 214, other customer data platform functionality 216, and data lake 204 of FIG. 2, the customer data platform GUI of FIG. 3, the CDM editor GUI of FIGS. 4-23, the method of flowchart 2400 of FIG. 24, step 2500 of FIG. 25, step 2600 of FIG. 26, step 2700 of FIG. 27 and the steps of flowchart 2800 of FIG. 28 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

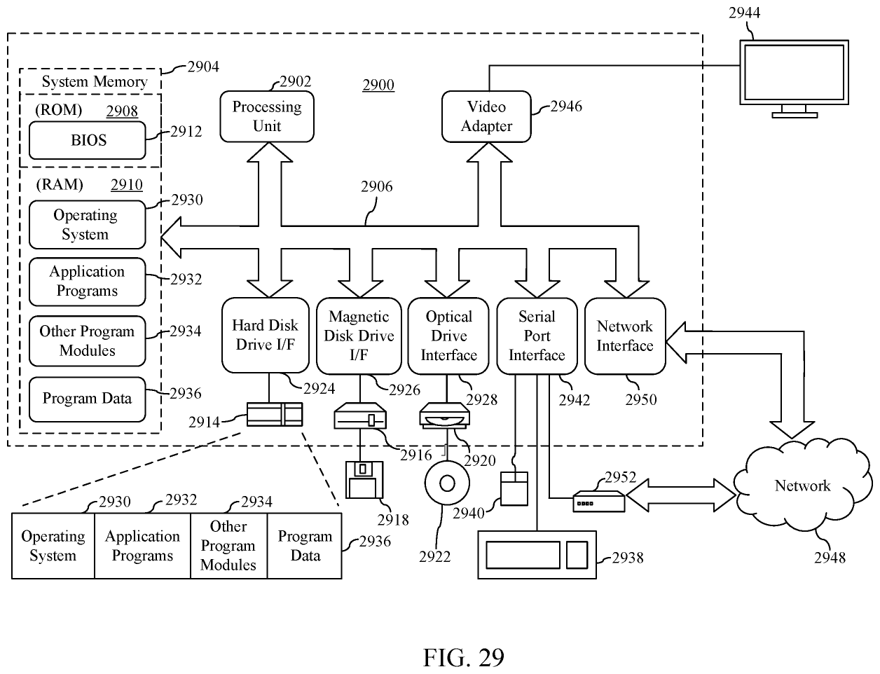

FIG. 29 depicts an example processor-based computer system 2900 that may be used to implement various embodiments described herein, including each of customer data platform 202, CDM attach utility 212, CDM editor 214, other customer data platform functionality 216, and data lake 204 of FIG. 2, the customer data platform GUI of FIG. 3, the CDM editor GUI of FIGS. 4-23, the method of flowchart 2400 of FIG. 24, step 2500 of FIG. 25, step 2600 of FIG. 26, step 2700 of FIG. 27 and the steps of flowchart 2800 of FIG. 28. The description of system 2900 provided herein is provided for purposes of illustration and is not intended to be limiting. Embodiments may be implemented in further types of computer systems, as would be known to persons skilled in the relevant art(s).

As shown in FIG. 29, system 2900 includes a processing unit 2902, a system memory 2904, and a bus 2906 that couples various system components including system memory 2904 to processing unit 2902. Processing unit 2902 may comprise one or more microprocessors or microprocessor cores. Bus 2906 represents one or more of any of several types of bus structures, including a memory bus or memory controller, a peripheral bus, an accelerated graphics port, and a processor or local bus using any of a variety of bus architectures. System memory 2904 includes read only memory (ROM) 2908 and random-access memory (RAM) 2910. A basic input/output system 2912 (BIOS) is stored in ROM 2908.

System 2900 also has one or more of the following drives: a hard disk drive 2914 for reading from and writing to a hard disk, a magnetic disk drive 2916 for reading from or writing to a removable magnetic disk 2918, and an optical disk drive 2920 for reading from or writing to a removable optical disk 2922 such as a CD ROM, DVD ROM, BLU-RAY™ disk or other optical media. Hard disk drive 2914, magnetic disk drive 2916, and optical disk drive 2920 are connected to bus 2906 by a hard disk drive interface 2924, a magnetic disk drive interface 2926, and an optical drive interface 2928, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules or components may be stored on the hard disk, magnetic disk, optical disk, ROM, or RAM. These program modules include an operating system 2930, one or more application programs 2932, other program modules 2934, and program data 2936. In accordance with various embodiments, the program modules may include computer program logic that is executable by processing unit 2902 to perform any or all the functions and features of customer data platform 202, CDM attach utility 212, CDM editor 214, other customer data platform functionality 216, and data lake 204 of FIG. 2, the customer data platform GUI of FIG. 3, the CDM editor GUI of FIGS. 4-23, the method of flowchart 2400 of FIG. 24, step 2500 of FIG. 25, step 2600 of FIG. 26, step 2700 of FIG. 27 and the steps of flowchart 2800 of FIG. 28 as described above.

A user may enter commands and information into system 2900 through input devices such as a keyboard 2938 and a pointing device 2940. Other input devices (not shown) may include a microphone, joystick, game controller, scanner, or the like. In one embodiment, a touch screen is provided in conjunction with a display 2944 to allow a user to provide user input via the application of a touch (as by a finger or stylus for example) to one or more points on the touch screen. These and other input devices are often connected to processing unit 2902 through a serial port interface 2942 that is coupled to bus 2906, but may be connected by other interfaces, such as a parallel port, game port, or a Universal Serial Bus (USB). Such interfaces may be wired or wireless interfaces.

A display 2944 is also connected to bus 2906 via an interface, such as a video adapter 2946. In addition to display 2944, system 2900 may include other peripheral output devices (not shown) such as speakers and printers.

System 2900 is connected to a network 2948 (e.g., a local area network or wide area network such as the Internet) through a network interface or adapter 2950, a modem 2952, or other suitable means for establishing communications over the network. Modem 2952, which may be internal or external, is connected to bus 2906 via serial port interface 2942. As used herein, the terms “computer program medium,” “computer-readable medium,” and “computer-readable storage medium” are used to generally refer to memory devices or storage structures such as the hard disk associated with hard disk drive 2914, removable magnetic disk 2918, removable optical disk 2922, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media. Embodiments are also directed to such communication media.

As noted above, computer programs and modules (including application programs 2932 and other program modules 2934) may be stored on the hard disk, magnetic disk, optical disk, ROM, or RAM. Such computer programs may also be received via network interface 2950, serial port interface 2942, or any other interface type. Such computer programs, when executed or loaded by an application, enable system 2900 to implement features of embodiments of the present methods and systems described herein. Accordingly, such computer programs represent controllers of the system 2900.

Embodiments are also directed to computer program products comprising software stored on any computer useable medium. Such software, when executed in one or more data processing devices, causes a data processing device(s) to operate as described herein. Embodiments of the present methods and systems employ any computer-useable or computer-readable medium, known now or in the future. Examples of computer-readable mediums include but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### IV. Additional Exemplary Embodiments

A system is described herein for creating or modifying data model metadata associated with data stored in one or more data files. The system includes at least one processing circuit; and memory connected to the at least one processing circuit, the memory storing computer program instructions. The computer program instructions are executable by the at least one processing circuit to: parse the data model metadata based on rules associated therewith to identify objects included therein; present a list of the identified objects within a graphical user interface (GUI); present within the GUI a set of controls that enable a user to modify an object in the list of identified objects, add an object to the list of identified objects, and delete an object in the list of identified objects; and responsive to interaction by the user with one or more of the GUI controls to modify an object in the list of identified objects, add an object to the list of identified objects, or delete an object in the list of identified objects: apply the modification of the object, the addition of the object, or the deletion of the object to the data model metadata; and update the list within the GUI to reflect the modification of the object, the addition of the object, or the deletion of the object.

In one embodiment of the foregoing system, the data model metadata comprises Common Data Model (CDM) metadata.

In another embodiment of the foregoing system, the identified objects comprise one or more of a manifest, an entity, an attribute, an entity partition location, or an entity partition location pattern.

In yet another embodiment of the foregoing system, the data model metadata comprises one or more files formatted in accordance with a data interchange format. The data interchange format may be one of JavaScript Objection Notation (JSON), Extensible Markup Language (XML), or Comma-Separated Values (CSV).

In still another embodiment of the foregoing system, the computer program instructions are further executable by the at least one processing circuit to present within the GUI a value of a property associated with each of the identified objects. The property may comprise one of a manifest name, an entity name, an attribute name, an attribute data format, a location of a partition location path, or a root location, pattern, or type of a partition location pattern.

In a further embodiment of the foregoing system, the computer program instructions are further executable by the at least one processing circuit to: enable the user to assign a value to a property of one of the identified objects or of an object to be added to the list of identified objects by only allowing the user to select from among a set of valid values for the property as specified by the rules associated with the data model metadata. The property may comprise, for example, a data format value of an attribute.

In a still further embodiment of the foregoing system, the computer program instructions are further executable by the at least one processing circuit to: enable the user to input a value of a property of one of the identified objects or of an object to be added to the list of identified objects; and responsive to the user inputting the value of the property, perform one or more of syntax checking the value or validating the value based on the rules associated with the data model metadata.

In an additional embodiment of the foregoing system, the computer program instructions are further executable by the at least one processing circuit to: enable the user to validate the modification of the object, the addition of the object or the deletion of the object by presenting to the user via the GUI at least one result of the modification of the object, the addition of the object, or the deletion of the object. Presenting to the user via the GUI the at least one result of the modification of the object, the addition of the object, or the deletion of the object may comprise: presenting to the user via the GUI a list of data files identified based on a user-provided value for a partition location path of an entity or for a partition location pattern of an entity. Presenting to the user via the GUI the at least one result of the modification of the object, the addition of the object, or the deletion of the object may also comprise: presenting to the user via the GUI a sample of data from the data stored in the one or more data files that is organized and formatted based at least in part on the modification of the object, the addition of the object, or the deletion of the object.

In another embodiment of the foregoing system, the computer program instructions are executable by the at least one processing circuit to: present a first set of GUI controls to enable the user to modify the object in the list of identified objects, add the object to the list of identified objects, or delete the object in the list of identified objects through a menu-driven interface; present a second set of GUI controls to enable the user to modify the object in the list of identified objects, add the object to the list of identified objects, or delete the object in the list of identified objects by enabling the user to edit the data model metadata in an editing window; and reflect changes to the data model metadata made via the menu driven interface in the editing window and reflect changes to the data model metadata made through the editing window in the menu driven interface.

In yet another embodiment of the foregoing system, the computer program instructions are executable by the at least one processing circuit to apply the modification of the object, the addition of the object, or the deletion of the object to the data model metadata by updating a plurality of inter-related data model metadata files.

In still another embodiment of the foregoing system, the computer program instructions are further executable by the at least one processing circuit to present data model metadata suggestions via the GUI, the data model metadata suggestions comprising one or more of: a suggested manifest name; a suggested entity name; a suggested entity partition location path; a suggested entity partition location pattern; a suggested attribute name; or a suggested attribute data format. The computer program instructions may be executable by the at least one processing circuit to present the data model metadata suggestions based on an analysis of one or more data model metadata files.

A computer-implemented method is also described herein for creating or modifying data model metadata associated with data stored in one or more data files. The method includes: parsing the data model metadata based on rules associated therewith to identify objects included therein; presenting a list of the identified objects within a graphical user interface (GUI); presenting within the GUI a set of controls that enable a user to modify an object in the list of identified objects, add an object to the list of identified objects, and delete an object in the list of identified objects; and responsive to interaction by the user with one or more of the GUI controls to modify an object in the list of identified objects, add an object to the list of identified objects, or delete an object in the list of identified objects: applying the modification of the object, the addition of the object, or the deletion of the object to the data model metadata; and updating the list within the GUI to reflect the modification of the object, the addition of the object, or the deletion of the object.

In one embodiment of the foregoing method, the data model metadata comprises Common Data Model (CDM) metadata.

In another embodiment of the foregoing method, the identified objects comprise one or more of a manifest, an entity, an attribute, an entity partition location, or an entity partition location pattern.

In yet another embodiment of the foregoing method, the data model metadata comprises one or more files formatted in accordance with a data interchange format. The data interchange format may be one of JavaScript Objection Notation (JSON), Extensible Markup Language (XML), or Comma-Separated Values (CSV).

In still another embodiment of the foregoing method, the method further comprises presenting within the GUI a value of a property associated with each of the identified objects. The property may comprise one of a manifest name, an entity name, an attribute name, an attribute data format, a location of a partition location path, or a root location, pattern, or type of a partition location pattern.

In a further embodiment of the foregoing method, the method further comprises: enabling the user to assign a value to a property of one of the identified objects or of an object to be added to the list of identified objects by only allowing the user to select from among a set of valid values for the property as specified by the rules associated with the data model metadata. The property may comprise, for example, a data format value of an attribute.

In a still further embodiment of the foregoing method, the method further comprises: enabling the user to input a value of a property of one of the identified objects or of an object to be added to the list of identified objects; and responsive to the user inputting the value of the property, performing one or more of syntax checking the value or validating the value based on the rules associated with the data model metadata.

In an additional embodiment of the foregoing method, the method further comprises: enabling the user to validate the modification of the object, the addition of the object, or the deletion of the object by presenting to the user via the GUI at least one result of the modification of the object, the addition of the object, or the deletion of the object. Presenting to the user via the GUI at least one result of the modification of the object, the addition of the object, or the deletion of the object may comprise: presenting to the user via the GUI a list of data files identified based on a user-provided value for a partition location path of an entity or for a partition location pattern of an entity. Presenting to the user via the GUI at least one result of the modification of the object, the addition of the object, or the deletion of the object may also comprise: presenting to the user via the GUI a sample of data from the data stored in the one or more data files that is organized and formatted based at least in part on the modification of the object, the addition of the object, or the deletion of the object.

In another embodiment of the foregoing method, the method further comprises: presenting a first set of GUI controls to enable the user to modify the object in the list of identified objects, add the object to the list of identified objects, or delete the object in the list of identified objects through a menu-driven interface; presenting a second set of GUI controls to enable the user to modify the object in the list of identified objects, add the object to the list of identified objects, or delete the object in the list of identified objects by enabling the user to edit the data model metadata in an editing window; and reflecting changes to the data model metadata made via the menu driven interface in the editing window and reflecting changes to the data model metadata made through the editing window in the menu driven interface.

In yet another embodiment of the foregoing method, applying the modification of the object, the addition of the object, or the deletion of the object to the data model metadata comprises updating a plurality of inter-related data model metadata files.

In still another embodiment of the foregoing method, the method further comprises presenting data model metadata suggestions via the GUI, the data model metadata suggestions comprising one or more of: a suggested manifest name; a suggested entity name; a suggested entity partition location path; a suggested entity partition location pattern; a suggested attribute name; or a suggested attribute data format. Presenting the data model metadata suggestions may comprise presenting data model metadata suggestions based on an analysis of one or more data model metadata files.

A computer program product is also described herein. The computer program product comprises a computer-readable storage medium having computer program logic recorded thereon that is executable by at least one processing circuit of a computing device to cause the at least one processing circuit to perform operations for creating or modifying data model metadata associated with data stored in one or more data files, the operations comprising: parsing the data model metadata based on rules associated therewith to identify objects included therein; presenting a list of the identified objects within a graphical user interface (GUI); presenting within the GUI a set of controls that enable a user to modify an object in the list of identified objects, add an object to the list of identified objects, and delete an object in the list of identified objects; and responsive to interaction by the user with one or more of the GUI controls to modify an object in the list of identified objects, add an object to the list of identified objects, or delete an object in the list of identified objects: applying the modification of the object, the addition of the object, or the deletion of the object to the data model metadata; and updating the list within the GUI to reflect the modification of the object, the addition of the object, or the deletion of the object.

In one embodiment of the foregoing computer program product, the data model metadata comprises Common Data Model (CDM) metadata.

In another embodiment of the foregoing computer program product, the identified objects comprise one or more of a manifest, an entity, an attribute, an entity partition location, or an entity partition location pattern.

In yet another embodiment of the foregoing computer program product, the data model metadata comprises one or more files formatted in accordance with a data interchange format. The data interchange format may be one of JavaScript Objection Notation (JSON), Extensible Markup Language (XML), or Comma-Separated Values (CSV).

In still another embodiment of the foregoing computer program product, the operations further comprise: presenting within the GUI a value of a property associated with each of the identified objects. The property may comprise one of a manifest name, an entity name, an attribute name, an attribute data format, a location of a partition location path, or a root location, pattern, or type of a partition location pattern.

In a further embodiment of the foregoing computer program product, the operations further comprise: enabling the user to assign a value to a property of one of the identified objects or of an object to be added to the list of identified objects by only allowing the user to select from among a set of valid values for the property as specified by the rules associated with the data model metadata. The property may comprise, for example, a data format value of an attribute.

In a still further embodiment of the foregoing computer program product, the operations further comprise: enabling the user to input a value of a property of one of the identified objects or of an object to be added to the list of identified objects; and responsive to the user inputting the value of the property, performing one or more of syntax checking the value or validating the value based on the rules associated with the data model metadata.

In a yet further embodiment of the foregoing computer program product, the operations further comprise: enabling the user to validate the modification of the object, the addition of the object, or the deletion of the object by presenting to the user via the GUI at least one result of the modification of the object, the addition of the object, or the deletion of the object. Presenting to the user via the GUI at least one result of the modification of the object, the addition of the object, or the deletion of the object may comprise: presenting to the user via the GUI a list of data files identified based on a user-provided value for a partition location path of an entity or for a partition location pattern of an entity. Presenting to the user via the GUI at least one result of the modification of the object, the addition of the object, or the deletion of the object may also comprise: presenting to the user via the GUI a sample of data from the data stored in the one or more data files that is organized and formatted based at least in part on the modification of the object, the addition of the object, or the deletion of the object.

In an additional embodiment of the foregoing computer program product, the operations further comprise: presenting a first set of GUI controls to enable the user to modify the object in the list of identified objects, add the object to the list of identified objects, or delete the object in the list of identified objects through a menu-driven interface; presenting a second set of GUI controls to enable the user to modify the object in the list of identified objects, add the object to the list of identified objects, or delete the object in the list of identified objects by enabling the user to edit the data model metadata in an editing window; and reflecting changes to the data model metadata made via the menu driven interface in the editing window and reflecting changes to the data model metadata made through the editing window in the menu driven interface.

In another embodiment of the foregoing computer program product, applying the modification of the object, the addition of the object, or the deletion of the object to the data model metadata comprises updating a plurality of inter-related data model metadata files.

In yet another embodiment of the foregoing computer program product, the operations further comprise presenting data model metadata suggestions via the GUI, the data model metadata suggestions comprising one or more of: a suggested manifest name; a suggested entity name; a suggested entity partition location path; a suggested entity partition location pattern; a suggested attribute name; or a suggested attribute data format. Presenting the data model metadata suggestions may comprise presenting data model metadata suggestions based on an analysis of one or more data model metadata files.

### V. Conclusion

While various embodiments of the present methods and systems have been described above, they have been presented by way of example only, and not limitation. It will be apparent to persons skilled in the relevant art that various changes in form and detail can be made therein without departing from the spirit and scope of the methods and systems. Thus, the breadth and scope of the present methods and systems should not be limited by any of the above-described exemplary embodiments but should be defined only in accordance with the following claims and their equivalents.

1. A system for creating or modifying data model metadata associated with data stored in one or more data files, comprising:
at least one processing circuit; and
memory connected to the at least one processing circuit, the memory storing computer program instructions executable by the at least one processing circuit to:
parse the data model metadata based on rules associated therewith to identify objects included therein;
present a list of the identified objects within a graphical user interface (GUI);
present within the GUI a set of controls that enable a user to modify an object in the list of identified objects, add an object to the list of identified objects, and delete an object in the list of identified objects; and
responsive to interaction by the user with one or more of the GUI controls to modify an object in the list of identified objects, add an object to the list of identified objects, or delete an object in the list of identified objects:
apply the modification of the object, the addition of the object, or the deletion of the object to the data model metadata;
automatically present to the user via the GUI at least one result of the modification of the object, the addition of the object, or the deletion of the object that includes a sample of data from the data stored in the one or more data files that is organized and formatted based at least in part on the modification of the object, the addition of the object, or the deletion of the object;
enable the user to validate the modification of the object, the addition of the object, or the deletion of the object based on the at least one result in the GUI; and
update the list within the GUI to reflect the modification of the object, the addition of the object, or the deletion of the object subsequent to automatically presenting to the user via the GUI the at least one result and enabling the user to validate.

2. The system of claim 1, wherein the data model metadata comprises Common Data Model (CDM) metadata and wherein the identified objects comprise one or more of a manifest, an entity, an attribute, an entity partition location, or an entity partition location pattern.

3. The system of claim 1, wherein the computer program instructions are further executable by the at least one processing circuit to:
enable the user to assign a value to a property of one of the identified objects or of an object to be added to the list of identified objects by only allowing the user to select from among a set of valid values for the property as specified by the rules associated with the data model metadata.

4. The system of claim 1, wherein the computer program instructions are further executable by the at least one processing circuit to:
enable the user to input a value of a property of one of the identified objects or of an object to be added to the list of identified objects; and
responsive to the user inputting the value of the property, perform one or more of syntax checking the value or validating the value based on the rules associated with the data model metadata.

5. (canceled)

6. The system of claim 1, wherein the computer program instructions are executable by the at least one processing circuit to present to the user via the GUI the at least one result of the modification of the object, the addition of the object, or the deletion of the object by:
presenting to the user via the GUI a list of data files identified based on a user-provided value for a partition location path of an entity or for a partition location pattern of an entity.

7. (canceled)

8. The system of claim 1, wherein the computer program instructions are executable by the at least one processing circuit to:
present a first set of GUI controls to enable the user to modify the object in the list of identified objects, add the object to the list of identified objects, or delete the object in the list of identified objects through a menu-driven interface;
present a second set of GUI controls to enable the user to modify the object in the list of identified objects, add the object to the list of identified objects, or delete the object in the list of identified objects by enabling the user to edit the data model metadata in an editing window; and
reflect changes to the data model metadata made via the menu driven interface in the editing window and reflect changes to the data model metadata made through the editing window in the menu driven interface.

9. The system of claim 1, wherein the computer program instructions are further executable by the at least one processing circuit to present data model metadata suggestions via the GUI, the data model metadata suggestions comprising one or more of:
a suggested manifest name;
a suggested entity name;
a suggested entity partition location path;
a suggested entity partition location pattern;
a suggested attribute name; or
a suggested attribute data format.

10. The system of claim 9, wherein the computer program instructions are executable by the at least one processing circuit to present the data model metadata suggestions based on an analysis of one or more data model metadata files.

11. A computer-implemented method for creating or modifying data model metadata associated with data stored in one or more data files, the method comprising:
parsing the data model metadata based on rules associated therewith to identify objects included therein;
presenting a list of the identified objects within a graphical user interface (GUI);
presenting within the GUI a set of controls that enable a user to modify an object in the list of identified objects, add an object to the list of identified objects, and delete an object in the list of identified objects; and
responsive to interaction by the user with one or more of the GUI controls to modify an object in the list of identified objects, add an object to the list of identified objects, or delete an object in the list of identified objects:
applying the modification of the object, the addition of the object, or the deletion of the object to the data model metadata;
automatically presenting to the user via the GUI at least one result of the modification of the object, the addition of the object, or the deletion of the object that includes a sample of data from the data stored in the one or more data files that is organized and formatted based at least in part on the modification of the object, the addition of the object, or the deletion of the object;
enabling the user to validate the modification of the object, the addition of the object, or the deletion of the object based on the at least one result in the GUI; and
updating the list within the GUI to reflect the modification of the object, the addition of the object, or the deletion of the object subsequent to automatically presenting to the user via the GUI the at least one result and enabling the user to validate.

12. The method of claim 11, further comprising:
enabling the user to assign a value to a property of one of the identified objects or of an object to be added to the list of identified objects by only allowing the user to select from among a set of valid values for the property as specified by the rules associated with the data model metadata.

13. The method of claim 11, further comprising:
enabling the user to input a value of a property of one of the identified objects or of an object to be added to the list of identified objects; and
responsive to the user inputting the value of the property, performing one or more of syntax checking the value or validating the value based on the rules associated with the data model metadata.

14. (canceled)

15. The method of claim 11, wherein enabling the user to validate the modification of the object, the addition of the object, or the deletion of the object by presenting to the user via the GUI at least one result of the modification of the object, the addition of the object, or the deletion of the object comprises:
presenting to the user via the GUI a list of data files identified based on a user-provided value for a partition location path of an entity or for a partition location pattern of an entity.

16. (canceled)

17. The method of claim 11, further comprising:
presenting a first set of GUI controls to enable the user to modify the object in the list of identified objects, add the object to the list of identified objects, or delete the object in the list of identified objects through a menu-driven interface;
presenting a second set of GUI controls to enable the user to modify the object in the list of identified objects, add the object to the list of identified objects, or delete the object in the list of identified objects by enabling the user to edit the data model metadata in an editing window; and
reflecting changes to the data model metadata made via the menu driven interface in the editing window and reflecting changes to the data model metadata made through the editing window in the menu driven interface.

18. The method of claim 11, further comprising presenting data model metadata suggestions via the GUI, the data model metadata suggestions comprising one or more of:
a suggested manifest name;
a suggested entity name;
a suggested entity partition location path;
a suggested entity partition location pattern;
a suggested attribute name; or
a suggested attribute data format.

19. The method of claim 18, wherein presenting the data model metadata suggestions comprises presenting data model metadata suggestions based on an analysis of one or more data model metadata files.

20. A computer program product comprising a computer-readable storage medium having computer program logic recorded thereon that is executable by at least one processing circuit of a computing device to cause the at least one processing circuit to perform operations for creating or modifying data model metadata associated with data stored in one or more data files, the operations comprising:
parsing the data model metadata based on rules associated therewith to identify objects included therein;
presenting a list of the identified objects within a graphical user interface (GUI);
presenting within the GUI a set of controls that enable a user to modify an object in the list of identified objects, add an object to the list of identified objects, and delete an object in the list of identified objects; and
responsive to interaction by the user with one or more of the GUI controls to modify an object in the list of identified objects, add an object to the list of identified objects, or delete an object in the list of identified objects:
applying the modification of the object, the addition of the object, or the deletion of the object to the data model metadata;
automatically presenting to the user via the GUI at least one result of the modification of the object, the addition of the object, or the deletion of the object that includes a sample of data from the data stored in the one or more data files that is organized and formatted based at least in part on the modification of the object, the addition of the object, or the deletion of the object;
enabling the user to validate the modification of the object, the addition of the object, or the deletion of the object based on the at least one result in the GUI; and
updating the list within the GUI to reflect the modification of the object, the addition of the object, or the deletion of the object subsequent to automatically presenting to the user via the GUI the at least one result and enabling the user to validate.

21. The computer program product of claim 20, the operations further comprising:
enabling the user to assign a value to a property of one of the identified objects or of an object to be added to the list of identified objects by only allowing the user to select from among a set of valid values for the property as specified by the rules associated with the data model metadata.

22. The computer program product of claim 20, the operations further comprising:
enabling the user to input a value of a property of one of the identified objects or of an object to be added to the list of identified objects; and
responsive to the user inputting the value of the property, performing one or more of syntax checking the value or validating the value based on the rules associated with the data model metadata.

23. The computer program product of claim 20, wherein enabling the user to validate the modification of the object, the addition of the object, or the deletion of the object by presenting to the user via the GUI at least one result of the modification of the object, the addition of the object, or the deletion of the object further comprises:
presenting to the user via the GUI a list of data files identified based on a user-provided value for a partition location path of an entity or for a partition location pattern of an entity.

24. The computer program product of claim 20, the operations further comprising:
presenting a first set of GUI controls to enable the user to modify the object in the list of identified objects, add the object to the list of identified objects, or delete the object in the list of identified objects through a menu-driven interface;
presenting a second set of GUI controls to enable the user to modify the object in the list of identified objects, add the object to the list of identified objects, or delete the object in the list of identified objects by enabling the user to edit the data model metadata in an editing window; and
reflecting changes to the data model metadata made via the menu driven interface in the editing window and reflecting changes to the data model metadata made through the editing window in the menu driven interface.
